(19) United States
(12) Patent Application Publication
(10) Pub. No.: US 2011/0275005 A1
(43) Pub. Date: Nov. 10, 2011

(54) Membrane Electrode Assemblies With Interfacial Layer

(75) Inventors: Yimin Zhu, Fremont, CA (US); Jay L. Goldman, Mountain View, CA (US); Baixin Qian, Sunnyvale, CA (US); Ionel C. Stefan, San Jose, CA (US); Masashi Muraoka, Nara (JP); Takenori Onishi, Nara (JP); Kohtaroh Saitoh, Nara (JP); Hirotaka Mizuhata, Nara (JP)

(73) Assignee: Nanosys, Inc, Palo Alto, CA (US)

(21) Appl. No.: 13/124,790

(22) PCT Filed: Oct. 22, 2009
(86) PCT No.: PCT/US09/61684

§ 371 Date: Jul. 11, 2011

Related U.S. Application Data
(62) Division of application No. 61/108,301, filed on Oct. 24, 2008.

(51) Int. Cl. H01M 8/10; B05D 5/12; H01M 4/92; B82Y 30/00

(52) U.S. Cl. 429/482; 427/115; 977/773; 977/762

(57) ABSTRACT

The present invention relates to interfacial layers for use m membrane electrode assemblies that comprise nanowire-supported catalysts, and fuel cells comprising such membrane electrode assemblies. The present invention also relates to methods of preparing membrane electrode assemblies and fuel cells comprising interfacial layers and nanowire-supported catalysts.

### BACKGROUND OF THE INVENTION

1. Field of the Invention

The present invention relates to membrane electrode assemblies and fuel cells comprising membrane electrode assemblies. The present invention also relates to methods of preparing membrane electrode assemblies and fuel cells.

2. Background of the Invention

Fuel cells are devices that convert the chemical energy of fuels, such as hydrogen and methanol, directly into electrical energy. The basic physical structure or building block of a fuel cell consists of an electrolyte layer in contact with a porous anode and cathode on either side. In a typical fuel cell, a fuel (e.g., methanol or hydrogen) is fed to an anode catalyst that converts the fuel molecules into protons (and carbon dioxide for methanol fuel cells), which pass through the proton exchange membrane to the cathode side of the cell. At the cathode catalyst, the protons (e.g., hydrogen atoms without an electron) react with the oxygen to form water. By connecting a conductive wire from the anode to the cathode side, the electrons stripped from fuel, hydrogen or methanol on the anode side, can travel to the cathode side and combine with oxygen, thus producing electricity. Fuel cells operating by electrochemical oxidation of hydrogen or methanol fuels at the anode and reduction of oxygen at the cathode are attractive power sources because of their high conversion efficiencies, low pollution, lightweight design, and high energy density.

For example, in direct methanol fuel cells (DMFCs), the liquid methanol (CH₃OH) is oxidized in the presence of water at the anode generating CO₂, hydrogen ions and the electrons that travel through the external circuit as the electric output of the fuel cell. The hydrogen ions travel through the electrolyte and react with oxygen from the air and the electrons from the external circuit to form water at the anode completing the circuit.

Anode Reaction: CH₃OH+H₂O→CO₂+6H++6e−

Cathode Reaction: 3/2O₂+6H++6e−→3H₂O

Overall Cell Reaction: CH₃OH−3/2O₂→CO₂+2H₂O

Initially developed in the early 1990s, DMFCs were not embraced because of their low efficiency and power density, as well as other problems. Improvements in catalysts and other recent developments have increased power density 20-fold and the efficiency may eventually reach 40%. These cells have been tested in a temperature range from about 50° C.-120° C. This low operating temperature and no requirement for a fuel reformer make the DMFC an excellent candidate for very small to mid-sized applications, such as cellular phones, laptops, cameras and other consumer products, up to automobile power plants. One of the drawbacks of the DMFC is that the low-temperature oxidation of methanol to hydrogen ions and carbon dioxide requires a more active catalyst, which typically means a larger quantity of expensive platinum (and/or ruthenium) catalyst is required.

A DMFC typically requires the use of ruthenium (Ru) as a catalyst component because of its high carbon monoxide (CO) tolerance and reactivity. Ru disassociates water to create an oxygenated species that facilitates the oxygenation of CO, which is produced from the methanol, to CO₂. Some existing DMFCs use nanometer-sized bimetallic Pt:Ru particles as the electro-oxidation catalyst because of the high surface area to volume ratio of the particles. The Pt:Ru nanoparticles are typically provided on a carbon support (e.g., carbon black, fullerene soot, or desulfurized carbon black) to yield a packed particle composite catalyst structure. Most commonly used techniques for creating the Pt:Ru carbon packed particle composite are the impregnation of a carbon support in a solution containing platinum and ruthenium chlorides followed by thermal reduction.

A multi-phase interface or contact is established among the fuel cell reactants, electrolyte, active Pt:Ru nanoparticles, and carbon support in the region of the porous electrode. The nature of this interface plays a critical role in the electrochemical performance of the fuel cell. It is known that only a portion of catalyst particle sites in packed particle composites are utilized because other sites are either not accessible to the reactants, or not connected to the carbon support network (electron path) and/or electrolyte (proton path). In fact, current packed particle composites only utilize about 20 to 30% of the catalyst particles. Thus, most DMFCs which utilize packed particle composite structures are highly inefficient.

In addition, connectivity to the anode and/or cathode is currently limited in current packed particle composite structures due to poor contacts between particles and/or tortuous diffusion paths for fuel cell reactants between densely packed particles. Increasing the density of the electrolyte or support matrix increases connectivity, but also decreases methanol diffusion to the catalytic site. Thus, a delicate balance must be maintained among the electrode, electrolyte, and gaseous phases in the porous electrode structure in order to maximize the efficiency of fuel cell operation at a reasonable cost. Much of the recent effort in the development of fuel cell technology has been devoted to reducing the thickness of cell components while refining and improving the electrode structure and the electrolyte phase, with the aim of obtaining a higher and more stable electrochemical performance while lowering cost. In order to develop commercially viable DMFCs, the electrocatalytic activity of the catalyst must be improved.

A structure combining nanowires, for example semiconductor nanowires, and graphene layers is disclosed in U.S. Patent Application Publication No. 2007-0212538 and U.S. Patent Application Publication No. 2008-0280169, the disclosures of each of which are incorporated by reference herein in their entireties for all purposes. These applications also disclose nanowire composite membrane electrode catalyst support assemblies comprising the various structures described throughout that provide a highly porous material with a high surface area, a high structural stability and a continuum structure. The composite structures are provided as a highly interconnected nanowire-supported catalyst structure interpenetrated with an electrolyte network to maximize catalyst utilization, catalyst accessibility, and electrical and ionic connectivity to thereby improve the overall efficiency of fuel cells, at lower cost, etc. However, there is still a need for improved adhesion between the various layers of membrane electrode assemblies, specifically the interface between a proton exchange membrane and the nanowire-supported catalysts.

### SUMMARY OF THE INVENTION

In one embodiment, the present invention provides fuel cell membrane electrode assemblies (MEAs). The MEAs suitably comprise a proton-conducting membrane layer, and an interfacial layer adjacent the proton-conducting membrane layer. The MEAs also comprise one or more nanowire-supported electrochemical catalysts adjacent the interfacial layer. Suitably, the proton-conducting membrane comprises a hydrocarbon.

In exemplary embodiments, the interfacial layer comprises carbon-supported electrochemical catalysts, can comprise a perfluorinated polymer electrolyte, or can comprise carbon black. Suitably, the electrochemical catalysts comprise nanoparticles of about 1 nm to about 10 nm, for example, nanoparticles comprising metal selected from the group consisting of Pt, Au, Pd, Ru, Re, Rh, Os, Ir, Fe, Co, Ni, Cu, Ag, V, Cr, Mo, W and alloys or mixtures thereof. In exemplary embodiments, the nanoparticles comprise Pt:Ru.

In suitable embodiments, the nanowire-supported electrochemical catalysts and the carbon-supported electrochemical catalysts comprise nanoparticles comprising metal selected from the group consisting of Pt, Au, Pd, Ru, Re, Rh, Os, Ir, Fe, Co, Ni, Cu, Ag, V, Cr, Mo, W and alloys or mixtures thereof, including Pt:Ru. Suitably the nanowires are selected from the group consisting of C, RuO2, SiC, GaN, TiO₂, SnO₂, WCx, MoCₓ, ZrC, WNₓ, and MoNₓ nanowires, wherein x is a positive integer.

In exemplary embodiments, the fuel cell membrane electrode assemblies further comprise an anode and/or cathode electrode, and suitably the MEA is a component in a methanol fuel cell, a formic acid fuel cell, an ethanol fuel cell, a hydrogen fuel cell or an ethylene glycol fuel cell.

In further embodiments, the present invention provides methods of preparing a fuel cell membrane electrode assembly. Suitably, a proton-conducting membrane layer is provided. Then, an interfacial layer is disposed adjacent the proton-conducting membrane layer, and one or more nanowire-supported electrochemical catalysts are disposed adjacent the interfacial layer. Suitably, the nanowire-supported electrochemical catalysts are sprayed on the interfacial layer.

Further embodiments, features, and advantages of the invention, as well as the structure and operation of the various embodiments of the invention are described in detail below with reference to accompanying drawings.

### BRIEF DESCRIPTION OF THE FIGURES

The invention is described with reference to the accompanying drawings. In the drawings, like reference numbers indicate identical or functionally similar elements. The drawing in which an element first appears is indicated by the left-most digit in the corresponding reference number.

FIGS. 1A-1B show membrane electrode assemblies comprising nanowire-supported electrochemical catalysts.

FIG. 1C shows a membrane electrode assembly comprising an interfacial layer in accordance with one embodiment of the present invention.

FIG. 2 shows a method of preparing membrane electrode assemblies in accordance with one embodiment of the present invention.

FIG. 3 shows the voltage and power density (PD) of Pt:Ru nanowire-associated catalysts in a fuel cell utilizing a EW1000 Nafion ionomer.

FIG. 4 shows the results of anode polarization representing the current density versus potential vs. DHE for four exemplary nanowire-associated catalysts of the present invention at different percentages of Pt and Pt:Ru catalyst and density.

FIG. 5 compares the Voltage and Power Density as a function of current density for Pt and Pt:Ru nanowire associated catalysts, including the impact of EW1000 Nafion on performance.

FIG. 6 shows the cathode polarization of two different concentrations of Pt-catalyst-associated nanowires of the present invention as compared with a Pt-Carbon-associated catalyst (TKK).

FIG. 7 shows the potential v. DHE versus current density for Pt:Ru-carbon supported catalysts (TKK and 172-9D) compared with three Pt:Ru-nanowire-supported electrochemical catalysts of the present invention.

FIG. 8 shows the DMFC polarization performance (potential (V) vs. current density (mA/cm²)) with and without the layer of carbon supported electrochemical catalysts in the anode electrode.

FIG. 9A shows anode performance with and without membrane treatment with solubilized perfluorinated ionomer solution (soak).

FIG. 9B shows DMFC polarization performance with and without membrane treatment with solubilized perfluorinated ionomer solution (soak).

### DETAILED DESCRIPTION OF THE INVENTION

It should be appreciated that the particular implementations shown and described herein are examples of the invention and are not intended to otherwise limit the scope of the present invention in any way. Indeed, for the sake of brevity, conventional electronics, manufacturing, semiconductor devices, and nanowire (NW), nanorod, nanotube, and nanoribbon technologies and other functional aspects of the systems (and components of the individual operating components of the systems) may not be described in detail herein. Furthermore, for purposes of brevity, the invention is frequently described herein as pertaining to nanowires, though other similar structures are also encompassed herein.

It should be appreciated that although nanowires are frequently referred to, the techniques are also applicable to other nanostructures, such as nanorods, nanotubes, nanotetrapods, nanoribbons and/or combinations thereof. It should further be appreciated that the manufacturing techniques described in U.S. Patent Application Publication No. 2007-0212538 and U.S. Patent Application Publication No. 2008-0280169, the disclosures of each of which are incorporated by reference herein in their entireties for all purposes, can be used to create a carbon-based layer (including non-crystalline carbon, such as non-basal plane carbon, as well as crystalline nanographite coatings) on the surface of a wide range of materials, including, but not limited to, conventional fibers and fiber structures; flat, curved and irregular surfaces; and various materials such as metal, semiconductors, ceramic foams, reticulated metals and ceramics. Further, the techniques would be suitable for application as catalysts, energy storage and conversion, separation, electrodes for medical devices, protective surfaces, or any other application.

As used herein, an “aspect ratio” is the length of a first axis of a nanostructure divided by the average of the lengths of the second and third axes of the nanostructure, where the second and third axes are the two axes whose lengths are most nearly equal to each other. For example, the aspect ratio for a perfect rod would be the length of its long axis divided by the diameter of a cross-section perpendicular to (normal to) the long axis.

The term “heterostructure” when used with reference to nanostructures refers to nanostructures characterized by at least two different and/or distinguishable material types. Typically, one region of the nanostructure comprises a first material type, while a second region of the nanostructure comprises a second material type. In another embodiment, the nanostructure comprises a core of a first material and at least one shell of a second (or third etc.) material, where the different material types are distributed radially about the long axis of a nanowire, a long axis of an arm of a branched nanocrystal, or the center of a nanocrystal, for example. A shell need not completely cover the adjacent materials to be considered a shell or for the nanostructure to be considered a heterostructure. For example, a nanocrystal characterized by a core of one material covered with small islands of a second material is a heterostructure. In other embodiments, the different material types are distributed at different locations within the nanostructure. For example, material types can be distributed along the major (long) axis of a nanowire or along a long axis or arm of a branched nanocrystal. Different regions within a heterostructure can comprise entirely different materials, or the different regions can comprise a base material.

As used herein, a “nanostructure” is a structure having at least one region or characteristic dimension with a dimension of less than about 500 nm, e.g., less than about 200 nm, less than about 100 nm, less than about 50 nm, or even less than about 20 nm. Typically, the region or characteristic dimension will be along the smallest axis of the structure. Examples of such structures include nanowires, nanorods, nanotubes, branched nanocrystals, nanotetrapods, tripods, bipods, nanocrystals, nanodots, quantum dots, nanoparticles, branched tetrapods (e.g., inorganic dendrimers), and the like. Nanostructures can be substantially homogeneous in material properties, or in other embodiments can be heterogeneous (e.g., heterostructures). Nanostructures can be, for example, substantially crystalline, substantially monocrystalline, polycrystalline, amorphous, or combinations thereof In one aspect, one of the three dimensions of the nanostructure has a dimension of less than about 500 nm, for example, less than about 200 nm, less than about 100 nm, less than about 50 nm, or even less than about 20 nm.

As used herein, the term “nanowire” generally refers to any elongated conductive or semiconductive material (or other material described herein) that includes at least one cross sectional dimension that is less than 500 nm, and preferably, less than 100 nm, and has an aspect ratio (length:width) of greater than 10, preferably greater than 50, and more preferably, greater than 100.

The nanowires can be substantially homogeneous in material properties, or in other embodiments can be heterogeneous (e.g. nanowire heterostructures). The nanowires can be fabricated from essentially any convenient material or materials, and can be, e.g., substantially crystalline, substantially monocrystalline, polycrystalline, amorphous, or combinations thereof. Nanowires can have a variable diameter or can have a substantially uniform diameter, that is, a diameter that shows a variance less than about 20% (e.g., less than about 10%, less than about 5%, or less than about 1%) over the region of greatest variability and over a linear dimension of at least 5 nm (e.g., at least 10 nm, at least 20 nm, or at least 50 nm). Typically the diameter is evaluated away from the ends of the nanowire (e.g., over the central 20%, 40%, 50%, or 80% of the nanowire). A nanowire can be straight or can be e.g., curved or bent, over the entire length of its long axis or a portion thereof In other embodiments, a nanowire or a portion thereof can exhibit two- or three-dimensional quantum confinement.

Examples of such nanowires include semiconductor nanowires as described in Published International Patent Application Nos. WO 02/17362, WO 02/48701, and WO 01/03208, carbon nanotubes, carbon nanofibers, and other elongated conductive or semiconductive structures of like dimensions, which are incorporated herein by reference.

As used herein, the term “nanorod” generally refers to any elongated conductive or semiconductive material (or other material described herein) similar to a nanowire, but having an aspect ratio (length:width) less than that of a nanowire. Note that two or more nanorods can be coupled together along their longitudinal axis. Alternatively, two or more nanorods can be substantially aligned along their longitudinal axis, but not coupled together, such that a small gap exists between the ends of the two or more nanorods. In this case, electrons can flow from one nanorod to another by hopping from one nanorod to another to traverse the small gap. The two or more nanorods can be substantially aligned, such that they form a path by which electrons can travel between electrodes.

A wide range of types of materials for nanowires, nanorods, nanotubes and nanoribbons can be used, including semiconductor material selected from, e.g., Si, Ge, Sn, Se, Te, B, C (including diamond), P, B—C, B—P(BP₆), B—Si, Si—C, Si—Ge, Si—Sn and Ge—Sn, SiC, BN, BP, BAs, AIN, AlP, AlAs, AlSb, GaN, GaP, GaAs, GaSb, InN, InP, InAs, ZnO, ZnS, ZnSe, ZnTe, CdS, CdSe, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuBr, CuI, AgF, AgCl, AgBr, AgI, BeSiN₂, CaCN₂, ZnGeP₂, CdSnAs₂, ZnSnSb₂, CuGeP₃, CuSi₂P₃, (Cu, Ag)(Al, Ga, In, Tl, Fe)(S, Se, Te)₂, Si₃N₄, Ge₃N₄, Al₂O₃, (Al, Ga, In)₂ (S, Se, Te)₃, Al₂CO, and an appropriate combination of two or more such semiconductors.

The nanowires can also be formed from other materials such as metals such as gold, nickel, palladium, iradium, cobalt, chromium, aluminum, titanium, tin and the like, metal alloys, polymers, conductive polymers, ceramics, and/or combinations thereof. Other now known or later developed conducting or semiconductor materials can be employed.

Nanowires may also be comprised of organic polymers, ceramics, inorganic semiconductors such as carbides and nitrides, and oxides (such as TiO₂ or ZnO), carbon nanotubes, biologically derived compounds, e.g., fibrillar proteins, etc. or the like. For example, in certain embodiments, nanowires such as disclosed in U.S. Patent Application Publication No. 2007-0212538 and U.S. Patent Application Publication No. 2008-0280169, are employed. Semiconductor nanowires can be comprised of a number of Group IV, Group III-V or Group II-VI semiconductors or their oxides. In one embodiment, the nanowires may include metallic conducting, semiconducting, carbide, nitride, or oxide materials such as RuO₂, SiC, GaN, TiO₂, SnO₂, WCₓ, MoCₓ, ZrC, WNₓ, MoNₓ etc. As used throughout, the subscript “x,” when used in chemical formulae, refers to a whole, positive integer (e.g., 1, 2, 3, 4, 5, 6, 7, 8, 9, 10, etc). It is suitable that the nanowires be made from a material that is resistant to degradation in a weak acid so that the nanowires are compatible with the reactants of a variety of different fuel cells. In further embodiments carbon nanotubes and carbon nanofibers, and, in certain embodiments, exclude “whiskers” or “nanowhiskers”, particularly whiskers having a diameter greater than 100 nm, or greater than about 200 nm, can be utilized in the practice of the present invention.

In other aspects, the semiconductor may comprise a dopant from a group consisting of: a p-type dopant from Group III of the periodic table; an n-type dopant from Group V of the periodic table; a p-type dopant selected from a group consisting of: B, Al and In; an n-type dopant selected from a group consisting of: P, As and Sb; a p-type dopant from Group II of the periodic table; a p-type dopant selected from a group consisting of: Mg, Zn, Cd and Hg; a p-type dopant from Group IV of the periodic table; a p-type dopant selected from a group consisting of: C and Si.; or an n-type dopant selected from a group consisting of: Si, Ge, Sn, S, Se and Te. Other now known or later developed dopant materials can be employed.

Additionally, the nanowires or nanoribbons can include carbon nanotubes, or nanotubes formed of conductive or semiconductive organic polymer materials, (e.g., pentacene, and transition metal oxides).

It should be understood that the spatial descriptions (e.g., “above”, “below”, “up”, “down”, “top”, “bottom”, etc.) made herein are for purposes of illustration only, and that devices of the present invention can be spatially arranged in any orientation or manner.

Nanomaterials have been produced in a wide variety of different ways. For example, solution based, surfactant mediated crystal growth has been described for producing spherical inorganic nanomaterials, e.g., quantum dots, as well as elongated nanomaterials, e.g., nanorods and nanotetrapods. Other methods have also been employed to produce nanomaterials, including vapor phase methods. For example, silicon nanocrystals have been reportedly produced by laser pyrolysis of silane gas.

Other methods employ substrate based synthesis methods including, e.g., low temperature synthesis methods for producing, e.g., ZnO nanowires as described by Greene et al. (“Low-temperature wafer scale production of ZnO nanowire arrays,” L. Greene, M. Law, J. Goldberger, F. Kim, J. Johnson, Y. Zhang, R. Saykally, P. Yang, Angew. Chem. Int. Ed. 42, 3031-3034, 2003), and higher temperature VLS methods that employ catalytic gold particles, e.g., that are deposited either as a colloid or as a thin film that forms a particle upon heating. Such VLS methods of producing nanowires are described in, for example, Published International Patent Application No. WO 02/017362, the full disclosure of which is incorporated herein by reference in its entirety for all purposes.

Nanostructures can be fabricated and their size can be controlled by any of a number of convenient methods that can be adapted to different materials. For example, synthesis of nanocrystals of various composition is described in, e.g., Peng et al. (2000) “Shape Control of CdSe Nanocrystals” Nature 404, 59-61; Puntes et al. (2001) “Colloidal nanocrystal shape and size control: The case of cobalt” Science 291, 2115-2117; U.S. Pat. No. 6,306,736 to Alivisatos et al. (Oct. 23, 2001) entitled “Process for forming shaped group III-V semiconductor nanocrystals, and product formed using process;” U.S. Pat. No. 6,225,198 to Alivisatos et al. (May 1, 2001) entitled “Process for forming shaped group II-VI semiconductor nanocrystals, and product formed using process;” U.S. Pat. No. 5,505,928 to Alivisatos et al. (Apr. 9, 1996) entitled “Preparation of III-V semiconductor nanocrystals;” U.S. Pat. No. 5,751,018 to Alivisatos et al. (May 12, 1998) entitled “Semiconductor nanocrystals covalently bound to solid inorganic surfaces using self-assembled monolayers;” U.S. Pat. No. 6,048,616 to Gallagher et al. (Apr. 11, 2000) entitled “Encapsulated quantum sized doped semiconductor particles and method of manufacturing same;” and U.S. Pat. No. 5,990,479 to Weiss et al. (Nov. 23, 1999) entitled “Organo luminescent semiconductor nanocrystal probes for biological applications and process for making and using such probes.”

Growth of nanowires having various aspect ratios, including nanowires with controlled diameters, is described in, e.g., Gudiksen et al. (2000) “Diameter-selective synthesis of semiconductor nanowires” J. Am. Chem. Soc. 122, 8801-8802; Cui et al. (2001) “Diameter-controlled synthesis of single-crystal silicon nanowires” Appl. Phys. Lett. 78, 2214-2216; Gudiksen et al. (2001) “Synthetic control of the diameter and length of single crystal semiconductor nanowires” J. Phys. Chem. B 105,4062-4064; Morales et al. (1998) “A laser ablation method for the synthesis of crystalline semiconductor nanowires” Science 279, 208-211; Duan et al. (2000) “General synthesis of compound semiconductor nanowires” Adv. Mater. 12, 298-302; Cui et al. (2000) “Doping and electrical transport in silicon nanowires” J. Phys. Chem. B 104, 5213-5216; Peng et al. (2000) “Shape control of CdSe nanocrystals” Nature 404, 59-61; Puntes et al. (2001) “Colloidal nanocrystal shape and size control: The case of cobalt” Science 291, 2115-2117; USPN 6,306,736 to Alivisatos et al. (Oct. 23, 2001) entitled “Process for forming shaped group III-V semiconductor nanocrystals, and product formed using process;” U.S. Pat. No. 6,225,198 to Alivisatos et al. (May 1, 2001) entitled “Process for forming shaped group II-VI semiconductor nanocrystals, and product formed using process”; U.S. Pat. No. 6,036,774 to Lieber et al. (Mar. 14, 2000) entitled “Method of producing metal oxide nanorods”; U.S. Pat. No. 5,897,945 to Lieber et al. (Apr. 27, 1999) entitled “Metal oxide nanorods”; U.S. Pat. No. 5,997,832 to Lieber et al. (Dec. 7, 1999) “Preparation of carbide nanorods;” Urbau et al. (2002) “Synthesis of single-crystalline perovskite nanowires composed of barium titanate and strontium titanate” J. Am. Chem. Soc., 124, 1186; Yun et al. (2002) “Ferroelectric Properties of Individual Barium Titanate Nanowires Investigated by Scanned Probe Microscopy” Nanoletters 2, 447; C. E. Baddour and C. Briens (2005) “Carbon nanotube synthesis: A review” International Journal of Chemical Reactor Engineering 3 R3; and K. P. De Jong and J. W. Geus (2000) “Carbon Nanofibers: Catalytic Synthesis and Applications” 42 481.

In certain embodiments, the nanowires are produced by growing or synthesizing these elongated structures on substrate surfaces. By way of example, published U.S. Patent Application No. US-2003-0089899-A1 discloses methods of growing uniform populations of semiconductor nanowires from gold colloids adhered to a solid substrate using vapor phase epitaxy. Greene et al. (“Low-temperature wafer scale production of ZnO nanowire arrays”, L. Greene, M. Law, J. Goldberger, F. Kim, J. Johnson, Y. Zhang, R. Saykally, P. Yang, Angew. Chem. Int. Ed. 42, 3031-3034, 2003) discloses an alternate method of synthesizing nanowires using a solution based, lower temperature wire growth process. A variety of other methods are used to synthesize other elongated nanomaterials, including the surfactant based synthetic methods disclosed in U.S. Pat. Nos. 5,505,928, 6,225,198 and 6,306,736, for producing shorter nanomaterials, and the known methods for producing carbon nanotubes, see, e.g., US-2002/0179434 to Dai et al., as well as methods for growth of nanowires without the use of a growth substrate, see, e.g., Morales and Lieber, Science, V. 279, p. 208 (Jan. 9, 1998). As noted herein, any or all of these different materials may be employed in producing the nanowires for use in the invention. For some applications, a wide variety of group III-V, II-VI and group IV semiconductors may be utilized, depending upon the ultimate application of the substrate or article produced. In general, such semiconductor nanowires have been described in, e.g., US-2003-0089899-A1, incorporated herein above.

Growth of branched nanowires (e.g., nanotetrapods, tripods, bipods, and branched tetrapods) is described in, e.g., Jun et al. (2001) “Controlled synthesis of multi-armed CdS nanorod architectures using monosurfactant system” J. Am. Chem. Soc. 123, 5150-5151; and Manna et al. (2000) “Synthesis of Soluble and Processable Rod-,Arrow-, Teardrop-, and Tetrapod-Shaped CdSe Nanocrystals” J. Am. Chem. Soc. 122, 12700-12706.

Synthesis of nanoparticles is described in, e.g., U.S. Pat. No. 5,690,807 to Clark Jr. et al. (Nov. 25, 1997) entitled “Method for producing semiconductor particles”; U.S. Pat. No. 6,136,156 to El-Shall, et al. (Oct. 24, 2000) entitled “Nanoparticles of silicon oxide alloys;” U.S. Pat. No. 6,413,489 to Ying et al. (Jul. 2, 2002) entitled “Synthesis of nanometer-sized particles by reverse micelle mediated techniques;” and Liu et al. (2001) “Sol-Gel Synthesis of Free-Standing Ferroelectric Lead Zirconate Titanate Nanoparticles” J. Am. Chem. Soc. 123, 4344. Synthesis of nanoparticles is also described in the above citations for growth of nanocrystals, nanowires, and branched nanowires, where the resulting nanostructures have an aspect ratio less than about 1.5.

Synthesis of core-shell nanostructure heterostructures, namely nanocrystal and nanowire (e.g., nanorod) core-shell heterostructures, are described in, e.g., Peng et al. (1997) “Epitaxial growth of highly luminescent CdSe/CdS core/shell nanocrystals with photostability and electronic accessibility” J. Am. Chem. Soc. 119, 7019-7029; Dabbousi et al. (1997) “(CdSe)ZnS core-shell quantum dots: Synthesis and characterization of a size series of highly luminescent nanocrysallites” J. Phys. Chem. B 101, 9463-9475; Manna et al. (2002) “Epitaxial growth and photochemical annealing of graded CdS/ZnS shells on colloidal CdSe nanorods” J. Am. Chem. Soc. 124, 7136-7145; and Cao et al. (2000) “Growth and properties of semiconductor core/shell nanocrystals with InAs cores” J. Am. Chem. Soc. 122, 9692-9702. Similar approaches can be applied to growth of other core-shell nanostructures.

Growth of nanowire heterostructures in which the different materials are distributed at different locations along the long axis of the nanowire is described in, e.g., Gudiksen et al. (2002) “Growth of nanowire superlattice structures for nanoscale photonics and electronics” Nature 415, 617-620; Bjork et al. (2002) “One-dimensional steeplechase for electrons realized” Nano Letters 2, 86-90; Wu et al. (2002) “Block-by-block growth of single-crystalline Si/SiGe superlattice nanowires” Nano Letters 2, 83-86; and U.S. patent application 60/370,095 (Apr. 2, 2002) to Empedocles entitled “Nanowire heterostructures for encoding information.” Similar approaches can be applied to growth of other heterostructures.

As described herein, and throughout co-assigned provisional Patent Application No. 60/738,100, filed Nov. 21, 2005, the entire contents of which are incorporated by reference herein, nanowire structures with multiple shells can also be fabricated, such as, for example, a conducting inner core wire (which may or may not be doped) (e.g., to impart the necessary conductivity for electron transport) and one or more outer-shell layers that provide a suitable surface for binding catalyst (and/or polymer electrolyte). For example, a multi-layer or multi-walled carbon nanotube (MWNT) can be formed in which the outermost shell layer is converted to silicon carbide to provide a surface (SiC) to bind catalyst (and/or polymer electrolyte) and a conductive carbon nanotube core to impart the necessary conductivity. In alternative embodiments, the core may consist of heavily doped material such as doped silicon, and a shell of a carbide, nitride etc. material (e.g., SiC) may then be formed on the core. The use of silicon as the core material leverages the extensive experience and infrastructure known for fabricating silicon nanowires. A carbide shell, such as SiC, WC, MoC or mixed carbide (e.g. WSiC) may be formed around the core material using a controlled surface reaction. SiC, WC and MoC are known for their high conductivity and chemical stability. In addition, these materials have been shown to have catalytic properties similar to those of precious metals, such as Pt, for methanol oxidation, and therefore may provide further performance enhancements in the nanowire bird's nest MEA. The precursor materials for the shell may be deposited on the core nanowire surface (e.g., silicon) by atomic layer deposition (ALD) and then converted to the carbide by high-temperature carbothermal reduction, for example.

Exemplary nanowires that can be used in the practice of the present invention include carbon-comprising nanowires, such as those disclosed in U.S. Patent Application Publication No. 2007-0212538 and U.S. Patent Application Publication No. 2008-0280169, the disclosures of each of which are incorporated by reference herein in their entireties for all purposes. As disclosed in U.S. Patent Application Publication No. 2007-0212538 and U.S. Patent Application Publication No. 2008-0280169, in suitable embodiments, the nanowires can form an interconnected nanowire network, comprising a plurality of nanowire structures, wherein carbon-based structures, in the form of nanographitic plates, attached to the various nanowire cores, connect the nanowire structures.

The structure of densely packed nanowires, with or without interconnecting nanographitic plates, is also referred to throughout as a “bird's nest” structure. This arrangement takes the form of a porous structure, wherein the size of pores between the nanowires and nanographitic plates are suitably mesopores and macropores. As used herein the term “mesopores” refers to pores that are larger than micropores (micropores are defined as less than about 2 nm in diameter), but smaller than macropores (macropores are defined as greater than about 50 nm in diameter), and therefore have a pore size in the range of greater than about 2 nm to less than about 50 nm in diameter. Suitably, interconnected nanowire network 300 will be substantially free of micropores, that is, less than about 0.1% of the pores will be micropores (i.e., less than about 2 nm in diameter), and suitably will have pores with a size of about 100 nm.

### Membrane Electrode Assemblies

As described throughout U.S. Patent Application Publication No. 2007-0212538 and U.S. Patent Application Publication No. 2008-0280169, the nanowire structures and interconnected nanowire networks disclosed therein can be used in various fuel cell applications and configurations. For example, catalysts comprising nanowires or interconnected nanowire networks and active catalytic nanoparticles dispersed on the surface of the nanowires/networks can be generated. Exemplary catalytic nanoparticles include, but are not limited to, Pt, Pd, Ru, Rh, Re, No, Fe, Co, Ag, Au, Cu, Zn and Sn, as well as metal alloy nanoparticles comprising two or more of such elements. These catalysts can be used as fuel cell cathodes, for example, a cathode comprising a nanowire or interconnected nanowire network and Pt catalytic nanoparticles. The catalysts can also be used as fuel cell anodes, for example, by using catalytic Pt:Ru nanoparticles.

Membrane electrode assemblies (MEA) are also described throughout U.S. Patent Application Publication No. 2007-0212538 and U.S. Patent Application Publication No. 2008-0280169, which comprise the cathode catalysts and anode catalysts, and also a proton-conducting membrane (e.g., a NAFION® membrane, DuPont, Wilmington, Del.). Such MEAs can be constructed using well known methods in the art, for example as set forth in U.S. Pat. Nos. 6,933,033; 6,926,985; and 6,875,537, the disclosures of each of which are incorporated herein by reference in their entireties. In exemplary embodiments, the proton-conducting membranes are disposed on one side with a cathode catalyst and on the other side an anode catalyst. Fuel cells comprising such MEAs, as well as gas diffusion layers (e.g., carbon fiber paper or carbon cloth), bipolar plates and end plates (e.g., machined graphite or molded conducting polymer composites) can also be constructed, as is well known in the art. Exemplary fuel cells that can be constructed using the nanowires and interconnected nanowire networks disclosed herein include proton exchange membrane fuel cells (PEMFC) and direct methanol fuel cells (DMFC). The nanowires and interconnected nanowire networks can also be used to generate anodes and cathodes, for example for use in lithium batteries and electrochemical capacitors. The components and construction of such batteries and capacitors is well known in the art.

In one embodiment, the present invention provides fuel cell membrane electrode assemblies. Suitably, the assemblies comprise a proton-conducting membrane layer, an interfacial layer adjacent the proton-conducting membrane layer, and one or more nanowire-supported electrochemical catalysts.

As discussed throughout U.S. Patent Application Publication No. 2007-0212538 and U.S. Patent Application Publication No. 2008-0280169, the nanowire-supported electrochemical catalysts (also called catalyst metal-associated nanowires herein and in U.S. Patent Application Publication No. 2007-0212538 and U.S. Patent Application Publication No. 2008-0280169) can be disposed adjacent a proton-conducting membrane. While the nanowire-supported electrochemical catalysts are able to associate with the proton-conducting membrane, the adhesive force between the membrane and the nanowire-supported electrochemical catalysts can be fairly low, and thus, the nanowire-supported electrochemical catalysts can delaminate, thereby reducing the efficiency of the fuel cell. In one embodiment, the present invention provides solutions to overcome these adhesion problems.

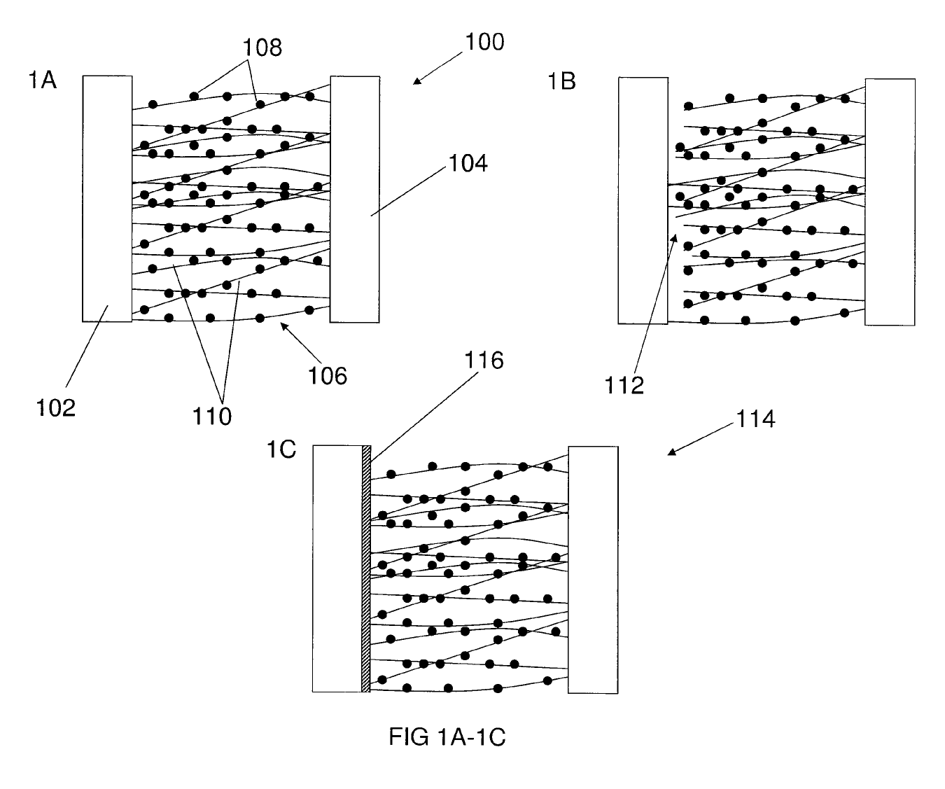

As shown in FIG. 1A, a fuel cell membrane electrode assembly 100 suitably comprises a proton-conducting membrane 102, an electrode 104 (e.g., an anode or a cathode electrode) and a plurality of nanowire-supported electrochemical catalysts 106. The nanowire-supported electrochemical catalysts suitably comprise nanowires 110, including the carbon-comprising nanowires disclosed in U.S. Patent Application Publication No. 2007-0212538 and U.S. Patent Application Publication No. 2008-0280169, and one or more electrochemical catalysts 108.

As noted in FIG. 1B, due to the possibility of a low adhesive force between the nanowire-supported electrochemical catalysts and the proton-conducting membrane, the nanowires often delaminate, or pull away from the surface of the membrane, for example, at 112, when utilized in MEAs and/or fuel cells. This increases the resistance between the membrane and the nanowires, thereby reducing the efficiency of the MEA and any fuel cell that comprises it.

As shown in FIG. 1C, an interfacial layer 116 can be disposed between the proton-conducting membrane 102 and the nanowire-supported electrochemical catalysts 106, to form membrane electrode assembly 114. As used herein, “interfacial layer” refers to a material that provides a structure between nanowires of nanowire-supported electrochemical catalysts and proton-conducting membrane that is compatible with both structures and increases the surface area and/or adhesion between the nanowires and the membrane. The interfacial layer can be sprayed, grown, deposited, spread, layered, coated (including spin-coated), painted, sputtered, etc., on the membrane so as to be in contact with proton exchange membrane 102.

In exemplary embodiments, proton-conducting membrane 102 comprises a hydrocarbon membrane, such as a polyhydrocarbon membrane. Additional materials for use as proton-conducting membrane 102 are well known in the art, and include, for example, polymers based on polybenzimidazole (PBI) or phosphoric acid.

Materials for use as proton-conducting membrane 102 are well known in the art, and include fluorinated membrane, for example, Nafion (Dupont), Hyflon PFA (Solvay Solexis), Flemion (Asahi Glass), or Aciplex (Asahi Glass). Additional materials for use as proton-conducting membrane 102 include hydrocarbon membrane which comprises non-fluorinated hydrocarbon electrolyte polymer, for example sulfonated polyether ether ketone, sulfonated polyether sulfone, sulfonated polyether imide, sulfonated polyphenylene ether, sulfonated poly(arylene ether sulfone), sulfonated poly(phenylene sulfide), alkylsulfonated poly(benzimidazole), etc. Suitably, the proton-conducting membrane of the present invention is hydrocarbon membrane. Details regarding relevant proton-conducting membrane can be found, e.g., in V. Neburchilov, et al. (2007) “A review of polymer electrolyte membranes for direct methanol fuel cells” J. Power Sources 169 221, and B. Smitha, et al. (2005) “Solid polymer electrolyte membranes for fuel cell applications—a review” J. Membrane Science 259 10, the entirety of each of which is hereby incorporated by reference herein.

In further embodiments, fuel cell membrane electrode assemblies comprise a proton-conducting membrane layer, an interfacial layer adjacent the proton-conducting membrane layer, and one or more nanowire-supported electrochemical catalysts adjacent the interfacial layer.

While not wishing to be bound by any theory, it is believed that the use of interfacial layer 116 increases the surface area of contact between the proton-conducting membrane and the nanowire-supported electrochemical catalysts, and thus, provides greater adhesion, between the nanowire-supported catalysts and the proton-conducting membrane. In general, the nanowire-supported electrochemical catalysts of the MEAs have a limited surface area as a result of the use of the nanowires for the catalyst support. Thus, interaction between the nanowires and the proton-conducting membrane is limited to this amount of surface area. The use of an interfacial layer can increase the surface area of contact between the nanowires (now in contact with the interfacial layer) and the proton-conducting membrane.

Further, providing the interfacial layer 116 on the surface of the proton-conducting membrane prevents methanol crossover, which refers to a phenomenon that methanol travels through the proton-conducting membrane. Preventing methanol crossover increases cell potential at all current densities. Further, preventing methanol crossover prevents, particularly in a region where a current density is high, the cell performance from being reduced due to the flooding of the cathode.

Furthermore, in an interface between the proton-conducting membrane 102 and the nanowire-supported electrochemical catalysts 106, the chemical reaction takes place more vigorously than in the other regions. Therefore, by providing carbon-supported catalysts on the interface as the interfacial layer 116, which carbon-supported catalysts work therein as an additional catalyst for promoting the chemical reaction, the cell performance is improved while cost reduction can be achieved by reducing the amount of catalysts used.

Similarly, in the interface between the proton-conducting membrane 102 and the nanowire-supported electrochemical catalysts 106, proton current is greater than in the other regions. Therefore, by providing a perfluorinated polymer electrolyte on the interface as the interfacial layer 116, which perfluorinated polymer electrolyte works therein as an additional ionic conductor, the cell performance is improved while cost reduction can be achieved by reducing the amount of catalysts used.

Moreover, since the nanowire-supported electrochemical catalysts 106 have needle shapes, integrating the nanowire-supported electrochemical catalysts 106 with the proton-conducting membrane 102 through a hot press process, in which the nanowire-supported electrochemical catalysts 106 are hot pressed to the proton-conducting membrane 102, may make holes through the proton-conducting membrane 102. On the other hand, providing the interfacial layer 116 on the interface can prevent holes from being made through the proton-conducting membrane 102, thus improving the reliability.

Interfacial layer 116 suitably comprises carbon-supported electrochemical catalysts. Suitably, the carbon of the carbon-supported electrochemical catalysts comprises carbon black, carbon powder or carbon particles. As used herein, carbon black refers to the material produced by the incomplete combustion of petroleum products. Carbon black is a form of amorphous carbon that has an extremely high surface area to volume ratio. In suitable embodiments, the carbon is carbon black-Cabot VULCAN® XC72 (Billerica, Mass.). Use of a carbon black or carbon powder as interfacial layer 116 on the proton-conducting membrane helps to increase the surface area of the membrane, thereby allowing for more interactions between the nanowires of the nanowire-supported electrochemical catalysts and the surface of the membrane (potentially resulting in additional non-covalent interactions), thereby increasing the adhesion between the supports and the membrane.

In the present invention, it is important to give different roles to the nanowire-supported electrochemical catalysts 106 and the interfacial layer 116. The nanowire-supported electrochemical catalysts 106 work as a layer for promoting efficient chemical reaction. The interconnected network structure, formed by the nanowires, provides pores suitable for diffusion of substances, thereby increasing a porosity. This leads to efficient electricity generation. On the other hand, the interfacial layer 116 improves the adhesion between the nanowire-supported electrochemical catalysts 106 and the proton-conducting membrane 102. The interfacial layer 116 is a fine-grained layer that is made of particulate material such as carbon black. This improves the adhesion between the nanowire-supported electrochemical catalysts 106 and the proton-conducting membrane 102. In terms of electricity generation performance, an interfacial layer 116 having a smaller thickness is better, and the thickness of the interfacial layer 116 is relatively smaller than the thickness of the nanowire-supported electrochemical catalysts 106.

In further embodiments, the interfacial layer 116 can simply comprise carbon black, such as carbon black-Cabot VULCAN® XC72 (Billerica, Mass.).

In further embodiments, interfacial layer 116 comprises a polymer, such as a perfluorinated polymer electrolyte. Examples of polymers that can be used as interfacial layer 116 include sulfonated fluoropolymers such as NAFION® (commercially available from DuPont Chemicals, Wilmington), and semi-crystalline fully-fluorinated melt processable fluoropolymers such as HYFLON® PFA and MFA (available from Solvay Solexis, West Deptford, N.J.).

Suitably, the electrochemical catalyst nanoparticles for use in the practice of the present invention comprise at least one metal selected from the group comprising one or more of Pt, Au, Pd, Ru, Re, Rh, Os, Ir, Fe, Co, Ni, Cu, Ag, V, Cr, Mo, W and alloys or mixtures thereof. For example the electrochemical catalyst nanoparticles suitably comprise mixtures of Pt and Ru, and are suitably Pt:Ru nanoparticles. In exemplary embodiments, the Pt:Ru nanoparticles are Pt:Ru nanoparticles comprising a specified ratio of atomic oxygen as disclosed in co-pending U.S. Provisional Patent Application No. 61/108,304, filed Oct. 24, 2008, entitled “Electrochemical Catalysts for Fuel Cells,” Atty. Docket No. 2132.0610000.

As used herein, a “nanoparticle” refers to a particle, crystal, sphere, or other shaped structure having at least one region or characteristic dimension with a dimension of less than about 500 nm, suitably less than about 200 nm, less than about 100 nm, less than about 50 nm, less than about 20 nm, or less than about 10 nm. Suitably, electrochemical catalyst nanoparticles for use in the practice of the present invention have a size of about 1 nm to about 10 nm, about 1 nm to about 9 nm, about 1 nm to about 8 nm, about 1 nm to about 7 um, about 1 nm to about 6 nm, about 1 nm to about 5 nm, about 1 nm to about 4 nm, about 1 nm to about 3 nm, or about 1 nm to about 2 nm, for example, about 1 nm, about 2 nm, about 3 nm, about 4 nm, about 5 nm, about 6 nm, about 7 nm, about 8 nm, about 9 nm, or about 10 nm.

In exemplary embodiments, both the nanowire-supported electrochemical catalysts, and the carbon-supported electrochemical catalysts, comprise nanoparticles comprising metal selected from the group consisting of Pt, Au, Pd, Ru, Re, Rh, Os, Ir, Fe, Co, Ni, Cu, Ag, V, Cr, Mo, W and alloys or mixtures thereof, and suitably, they both comprise nanoparticles of the same metal(s), for example, both can comprise Pt:Ru nanoparticles.

As described throughout, and in U.S. Patent Application Publication No. 2007-0212538 and U.S. Patent Application Publication No. 2008-0280169, suitably the nanowires of the nanowire-supported electrochemical catalysts are nanowires selected from the group consisting of C, RuO₂, SiC, GaN, TiO₂, SnO₂, WCₓ, MoCₓ, ZrC, WNₓ, and MoNx nanowires, wherein x is a positive integer. Suitably, the nanowires are carbon-comprising nanowires, such as carbon nanotubes, carbon nanofiber, and SiC nanowires.

In further embodiments, the fuel cell membrane electrode assemblies of the present invention further comprise an anode and/or cathode electrode, for example, 104, as shown in FIGS. 1A-1C. The fuel cell membrane electrode assemblies of the present invention can be a component of any fuel cell, for example, a methanol fuel cell, a formic acid fuel cell, an ethanol fuel cell, a hydrogen fuel cell or an ethylene glycol fuel cell.

The nanowire portion of an anode (and/or cathode) electrode may be synthesized on a growth substrate, and then transferred and incorporated into the membrane electrode assembly structure of the fuel cell. For example, in certain aspects, inorganic semiconductor or semiconductor oxide nanowires are grown on the surface of a growth substrate using a colloidal catalyst based VLS synthesis method described in U.S. Patent Application Publication No. 2007-0212538 and U.S. Patent Application Publication No. 2008-0280169, and known in the art. In accordance with this synthesis technique, the colloidal catalyst (e.g., gold, platinum etc. particles) is deposited upon the desired surface of the substrate. The substrate including the colloidal catalyst is then subjected to the synthesis process which generates nanowires attached to the surface of the substrate. Other synthetic methods include the use of thin catalyst films, e.g., 50 nm or less, deposited over the surface of the substrate. The heat of the VLS process then melts the film to form small droplets of catalyst that forms the nanowires. Typically, this latter method may be employed where fiber diameter homogeneity is less critical to the ultimate application. Typically, growth catalysts comprise metals, e.g., gold or platinum, and may be electroplated or evaporated onto the surface of the substrate or deposited in any of a number of other well known metal deposition techniques, e.g., sputtering etc. In the case of colloid deposition, the colloids are typically deposited by first treating the surface of the substrate so that the colloids adhere to the surface. Such treatments include those that have been described in detail previously, i.e., polylysine treatment, etc. The substrate with the treated surface is then immersed in a suspension of colloid.

Following growth of the nanowires, the nanowires are then harvested from their synthesis location. The free standing nanowires are then introduced into or deposited upon the relevant surface of the fuel cell component such as the gas diffusion layer(s) or the interfacial layer on the proton exchange membrane, for example, by spray/brush painting, solution coating, casting, electrolytic deposition, filtering a fluid suspension of the nanowires, and combinations thereof. For example, such deposition may simply involve immersing the component of interest (e.g., one or more of the gas diffusion layers or the proton exchange membrane with the interfacial layer) into a suspension of such nanowires, or may additionally involve pre-treating all or portions of the component to functionalize the surface or surface portions for wire attachment. The nanowires may also be introduced into a solution (e.g., methanol, polyethylene glycol or water), filtered (e.g., vacuum filtered over a polyvinylidene fluoride (PVDF) membrane) to give them a dense, intertwined mat or “bird's nest structure,” removed from the filter after drying and washing, and then heat treated (e.g., annealed) at high temperatures. The resulting porous sheet of nanowires (whether interconnected with nanographitic plates or not) can then be incorporated into the membrane electrode assembly of the fuel cell. A variety of other deposition methods, e.g., as described in U.S. Patent Application Publication No. 20050066883, published Mar. 31, 2005, and U.S. Pat. No. 6,962,823, the full disclosures of which are incorporated herein by reference in their entirety for all purposes, can also be used. The nanowires may also be grown directly on one or more of the fuel cell components such as one or more of the bipolar plates, gas diffusion layers, and/or the interfacial layer on a proton exchange membrane.

If methanol is used as fuel, liquid methanol (CH₃OH) is oxidized in the presence of water at the anode generating CO₂, hydrogen ions and the electrons that travel through the external circuit as the electric output of the fuel cell. The hydrogen ions travel through the electrolyte membrane and react with oxygen from the air and the electrons from the external circuit to form water at the cathode completing the circuit. Anode and cathode electrodes each contact bipolar plates. The bipolar plates typically have channels and/or grooves in their surfaces that distribute fuel and oxidant to their respective catalyst electrodes, allow the waste, e.g., water and CO₂ to get out, and may also contain conduits for heat transfer. Typically, bipolar plates are highly electrically conductive and can be made from graphite, metals, conductive polymers, and alloys and composites thereof Materials such as stainless steel, aluminum alloys, carbon and composites, with or without coatings, are good viable options for bipolar end plates in PEM fuel cells. Bipolar plates can also be formed from composite materials comprising highly-conductive or semiconducting nanowires incorporated in the composite structure (e.g., metal, conductive polymer etc.). The shape and size of the components of the fuel cell can vary over a wide range depending on the particular design.

As discussed throughout U.S. Patent Application Publication No. 2007-0212538 and U.S. Patent Application Publication No. 2008-0280169, because the generation of surface functional groups on nanowires, e.g., nanowires such as SiC or GaN, is relatively straightforward, catalyst nanoparticles such as Pt and/or Pt:Ru (as well as a proton conducting polymer (e.g., NAFION®)), can be facilely deposited on the nanowires, e.g., without agglomeration of the particles. Each catalyst particle is then directly connected to the anode (and cathode) through the nanowire core. The multiple electrical connectivity of the interconnected nanowires secures the electronic route from Pt to the electron conducting layer. The use of nanowires and the resulting guaranteed electronic pathway eliminate the previously mentioned problem with conventional PEMFC strategies where the proton conducting medium (e.g., NAFION®) would isolate the carbon particles in the electrode layer. Eliminating the isolation of the carbon particles supporting the electrode layer improves the utilization rate of Pt.

A plurality of MEAs as shown in FIG. 1C can be combined to form a fuel cell stack having separate anode electrodes and cathode electrodes separated by respective proton exchange membranes comprising interfacial layers. The cells within the stacks are connected in series by virtue of the bipolar plates such that the voltages of the individual fuel cells are additive.

The nanowires in the nanowire networks each are physically and/or electrically connected to one or more other wires in the network to form an open, highly branched, porous, intertwined structure, with low overall diffusion resistance for reactants and waste diffusion, high structural stability and high electrical connectivity for the electrons to ensure high catalytic efficiency, thus leading to high power density and lower overall cost. It is important to note that even if two wires are not in actual direct physical contact with each other (or with a catalyst particle), it is possible that at some small distance apart, they may still be able to transfer charges (e.g., be in electrical contact). Preferentially, each nanowire is physically and/or electrically connected to at least one or more other nanowires in the network. The multiple connectivity of the nanowires ensures that if one wire breaks or is damaged in the system, for example, that all points along the wire still connect to the anode (and cathode) electrode along different paths (e.g., via other nanowires in the network). This provides substantially improved electrical connectivity and stability as compared to previous packed particle composite structures. The wires may extend all the way (or only part way) between the anode (and cathode) gas diffusion layers bipolar plate and the interfacial layer on the proton exchange membrane. In the case where the wires do not extend all the way between a gas diffusion layer and the interfacial layer, the wires may extend from the gas diffusion layer toward the interfacial layer, but not reach the interfacial layer, and the interfacial layer can extend from the membrane toward the gas diffusion layer, but not reach the gas diffusion layer (but not the other way around) to ensure that electrons are efficiently transferred to the anode, and protons are transferred towards the cathode.

The nanowires are suitably dispersed in a polymer electrolyte material which coats the surface of nanowires in the branched nanowire network to provide sufficient contact points for proton (e.g., H+) transport. Polymer electrolytes can be made from a variety of polymers including, for example, polyethylene oxide, poly (ethylene succinate), poly (β-propiolactone), and sulfonated fluoropolymers such as NAFION® (commercially available from DuPont Chemicals, Wilmington). A suitable cation exchange membrane is described in U.S. Pat. No. 5,399,184, for example, the disclosure of which is incorporated herein by reference. Alternatively, the proton conductive membrane can be an expanded membrane with a porous microstructure where an ion exchange material impregnates the membrane effectively filling the interior volume of the membrane. U.S. Pat. No. 5,635,041, incorporated herein by reference, describes such a membrane formed from expanded polytetrafluoroethylene (PTFE). The expanded PTFE membrane has a microstructure of nodes interconnected by fibrils. Similar structures are described in U.S. Pat. No. 4,849,311, the disclosure of which is incorporated herein by reference. In additional embodiments, proton shuttle molecules can be attached to the nanowires. For example, short hydrocarbon chains comprising —SO₃H groups (e.g., 2-6 carbons long) can be grafted to the nanowires. Use of such proton shuttle molecules can reduce the amount of NAFION® or other ionomer required, thereby increasing the available surface area of the catalytic nanoparticles.

An exemplary method for grafting the short hydrocarbon chains comprising —SO₃H groups is represented in U.S. Patent Application Publication No. 2007-0212538 and U.S. Patent Application Publication No. 2008-0280169. The porous structure of the interconnected nanowire network provides an open (non-tortuous) diffusion path for fuel cell reactants to the catalyst (e.g., catalyst particles) deposited on the nanowires. The void spaces between the interconnected nanowires form a highly porous structure. The effective pore size will generally depend upon the density of the nanowire population, as well as the thickness of electrolyte layer, and to some extent, the width of the nanowires used. All of these parameters are readily varied to yield a nanowire network having a desired effective porosity. For example, preferred nanowire networks have a porosity adequate to provide for an even flow of reactants while maintaining adequate electrical conductivity and mechanical strength. Also, the porosity of the nanowire network provides for water management within the cell. The branched nanowire network preferably is sufficiently porous to pass fuel gases and water vapor through it without providing a site for water condensation that would block the pores of the network and prevent vapor transport. The mean pore size generally ranges from about 0.002 microns to about 10.0 microns, e.g., less than about 1 μm, e.g., less than about 0.2 μm, e.g., between about 0.005 and 0.2 μm. The total porosity of the branched nanowire structure may be easily controlled between about 30% to 95%, for example, e.g., between about 40% to 60%, while still ensuring electrical connectivity to the anode and cathode electrodes.

The nanowire networks are suitably employed as the support for the subsequent metal (e.g., platinum, ruthenium, gold, or other metal) electrochemical catalyst, which may be coated or deposited, for example, on the nanowires. Appropriate catalysts for fuel cells generally depend on the reactants selected. For example, the metallic catalyst (also called catalyst metals throughout) may be selected from the group comprising, but not limited to, one or more of platinum (Pt), ruthenium (Ru), iron (Fe), cobalt (Co), gold (Au), chromium (Cr), molybdenum (Mo), tungsten (W), manganese (Mn), technetium (Tc), rhenium (Re), osmium (Os), rhodium (Rh), iridium (Ir), nickel (Ni), palladium (Pd), copper (Cu), silver (Ag), zinc (Zn), tin (Sn), aluminum (Al), and combinations and alloys thereof (such as bimetallic Pt:Ru nanoparticles). Suitable catalyst materials for oxidation of hydrogen or methanol fuels specifically include metals such as, for example, Pd, Pt, Ru, Rh and alloys thereof.

The metal catalyst may be deposited or otherwise associated with the nanowire-supports as a thin film (e.g., less than about 10 angstroms in thickness) (or a series of catalyst particles) using a variety of catalyst deposition techniques including, for example, chemical vapor deposition, electrochemical deposition (e.g., electroplating or electroless chemical plating), physical vapor deposition, solution impregnation and precipitation, colloid particle absorption and deposition, atomic layer deposition, and combinations thereof. The amount of the catalyst metal coated by the methods described herein is preferably in the range of about 0.5%-85% by weight, suitably about 10%-85%, more suitably about 20-40% by weight, based on the total amount of catalyst metal and supports (e.g., nanowires).

The catalyst may be deposited on the nanowire structures as a plurality of nanometer-sized metallic catalyst particles (e.g., between about 1 and 50 nm in diameter, e.g., less than about 10 nm in diameter, e.g., between about 1 and 5 nm in diameter), in solution. By derivatizing the external surface of the nanowire supports with one or more functional linker moieties (e.g., a chemically reactive group) such as one or more carboxylic acid groups, nitric acid groups, hydroxyl groups, amine groups, sulfonic acid groups, and the like, the nanoparticles bind to the surface of the supports. The catalysts particles (or film) can be attached to the nanowire supports either uniformly or non-uniformly. The catalyst particles can be spherical, semi-spherical or non-spherical. The catalyst particles can form islands on the surface of the supports or can form a continuous coating on the surface of the nanowire supports (for example, as in a core-shell arrangement, or stripes or rings along the length of a nanowire, etc). The catalyst particles may be attached to the nanowire surface before or after the nanowire network is incorporated/deposited into the MEA of the fuel cell.

Following catalyst deposition, a proton conducting polymer such as NAFION® may optionally be deposited on the nanowire surface between catalyst particle sites, for example, by functionalizing the surface of the nanowire with a second functional group (different from the catalyst functional group, when used) that preferentially binds the electrolyte or which promotes consistent and/or controlled wetting. The polymer can either be a continuous or discontinuous film on the surface of the support. For example, the polymer electrolyte can be uniformly wetted on the surface of the nanowire, or can form point-contacts along the length of the nanowire. The nanowires may be functionalized with a sulfonated hydrocarbon molecule, a fluorocarbon molecule, a short chain polymer of both types of molecules, or a branched hydrocarbon chain, for example, which may be attached to a nanowire surface via silane chemistry. Those of skill in the art will be familiar with numerous functionalizations and functionalization techniques which are optionally used herein (e.g., similar to those used in construction of separation columns, bio-assays, etc.). Alternatively, instead of binding ionomer to the nanowires through a chemical binding moiety, the nanowires may be directly functionalized to make them proton conductive. For example, the nanowires may be functionalized with a surface coating such as a perfluorinated sulfonated hydrocarbon using well-known functionalization chemistries.

For example, details regarding relevant moiety and other chemistries, as well as methods for construction/use of such, can be found, e.g., in Hermanson Bioconjugate Techniques Academic Press (1996), Kirk-Othmer Concise Encyclopedia of Chemical Technology (1999) Fourth Edition by Grayson et al. (ed.) John Wiley & Sons, Inc., New York and in Kirk-Othmer Encyclopedia of Chemical Technology Fourth Edition (1998 and 2000) by Grayson et al. (ed.) Wiley Interscience (print edition)/ John Wiley & Sons, Inc. (e-format). Further relevant information can be found in CRC Handbook of Chemistry and Physics (2003) 83rd edition by CRC Press. Details on conductive and other coatings, which can also be incorporated onto the nanowire surface by plasma methods and the like can be found in H. S. Nalwa (ed.), Handbook of Organic Conductive Molecules and Polymers, John Wiley & Sons 1997. See also, “ORGANIC SPECIES THAT FACILITATE CHARGE TRANSFER TO/FROM NANOCRYSTALS,” U.S. Pat. No. 6,949,206. Details regarding organic chemistry, relevant for, e.g., coupling of additional moieties to a functionalized surface can be found, e.g., in Greene (1981) Protective Groups in Organic Synthesis, John Wiley and Sons, New York, as well as in Schmidt (1996) Organic Chemistry Mosby, St Louis, Mo., and March's Advanced Organic Chemistry Reactions, Mechanisms and Structure, Fifth Edition (2000) Smith and March, Wiley Interscience New York ISBN 0-471-58589-0, and U.S. Patent Publication No. 20050181195, published Aug. 18, 2005. Those of skill in the art will be familiar with many other related references and techniques amenable for functionalization of surfaces herein.

The polymer electrolyte coating may be directly linked to the surface of the nanowires, e.g., through silane groups, or may be coupled via linker binding groups or other appropriate chemical reactive groups to participate in linkage chemistries (derivitization) with linking agents such as, e.g., substituted silanes, diacetylenes, acrylates, acrylamides, vinyl, styryls, silicon oxide, boron oxide, phosphorus oxide, N-(3-aminopropyl)3-mercapto-benzamide, 3-aminopropyl-trimethoxysilane, 3-mercaptopropyl-trimethoxysilane, 3-maleimidopropyl-trimethoxysilane, 3-hydrazidopropyl-trimethoxysilane, trichloro-perfluoro octyl silane, hydroxysuccinimides, maleimides, haloacetyls, hydrazines, ethyldiethylamino propylcarbodiimide, and/or the like. Other surface functional chemistries can be used such as those that would be known to one of ordinary skill in the art.

In addition, a solubilized perfluorosulfonate ionomer (e.g., NAFION®) may be placed into the space between the nanowires. The interconnected nanowires, when not grown in situ on one of the bipolar plates, the gas diffusion layers, and/or the interfacial layer on the proton exchange membrane, may then be placed between the gas diffusion layers on either side of a proton exchange membrane, and the assembly hot pressed to form a complete membrane-electrode assembly fuel cell according to the present invention. The pressing temperature is determined such that the proton exchange membrane is softened in that temperature range, for example, to 125° Celsius for NAFION®. The pressure level is about 200 kgf/cm². In order to efficiently distribute fuel/oxygen to the surface of the anode/cathode electrodes a gas diffusion layer is typically needed in conventional fuel cells. Typically, a carbon fiber cloth is used as the gas diffusion layer. With the interconnecting nanowire composite membrane electrode catalyst support assembly of the present invention, this gas diffusion layer can be eliminated due to the superior structure of the nanowire-based electrodes. In such case, the interconnected nanowires may then be placed between bipolar plates on either side of a proton exchange membrane.

### Methods of Preparing Membrane Electrode Assemblies

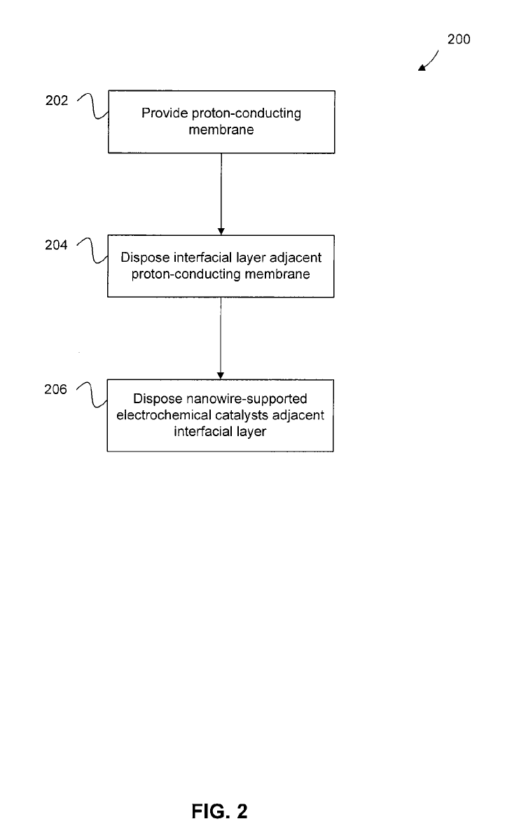

Methods for preparing fuel cell membrane electrode assemblies are also provided, for example, as shown in flowchart 200 of FIG. 2, with reference to FIGS. 1A-1C. In suitable embodiments, in 202 of flowchart 200, a proton-conducting membrane layer 102 is provided. Then, an interfacial layer 116 is disposed adjacent the proton-conducting membrane layer 102 in 204 of flowchart 200. In 206 of flowchart 200, one or more nanowire-supported electrochemical catalysts 106 are then disposed adjacent the interfacial layer 116.

As used herein, the terms “disposed” and “disposed adjacent” are used to mean that the components are arranged next to each other such that the components are capable of interacting with one another so as to act as a membrane electrode assembly. Disposing components adjacent one another, includes, layering, applying, spraying, coating, spreading, or any other form of application of the various components.

As described herein suitably, the proton-conducting membrane is a hydrocarbon proton-conducting membrane, such as a polyhydrocarbon membrane, for example a hydrocarbon polymer membrane. In exemplary embodiments, interfacial layer 116 comprises carbon-supported electrochemical catalysts, such as carbon black supported Pt or Pt:Ru, as described herein. In further embodiments, the interfacial layer can comprise a polymer, such as a perfluorinated polymer electrolyte. Examples of polymers that can be used include sulfonated fluoropolymers such as NAFION®, and semi-crystalline fully-fluorinated melt processable fluoropolymers such as HYFLON® PFA and MFA. In still further embodiments, the interfacial layer can comprise carbon black, such as carbon black-Cabot VULCAN° XC72 (Billerica, Mass.).

Methods of disposing interfacial layer on proton-conducting membrane include layering, spraying, spreading, spin-coating, dipping, painting, sputtering, etc. In suitable embodiments, the interfacial layer is sprayed onto proton-conducting membrane, for example using a computer-controlled spray nozzle.

As discussed throughout, suitably nanowire-supported electrochemical catalysts comprise nanoparticles of about 1 nm to about 30 nm, for example, about 1 nm to about 10 nm. Suitably, the nanoparticles comprise metal selected from the group consisting of Pt, Au, Pd, Ru, Re, Rh, Os, Ir, Fe, Co, Ni, Cu, Ag, V, Cr, Mo, W and alloys or mixtures thereof, for example, Pt:Ru nanoparticles. As described throughout, exemplary nanowires for use in the practice of the present invention are selected from the group consisting of C, RuO₂, SiC, GaN, TiO₂, SnO₂, WCₓ, MoCₓ, ZrC, WNₓ, and MoNₓ nanowires, wherein x is a positive integer.

In exemplary embodiments, the interfacial layer comprises carbon-supported electrochemical catalysts. For example, a carbon black supported electrochemical catalyst nanoparticles comprising metal selected from the group consisting of Pt, Au, Pd, Ru, Re, Rh, Os, Ir, Fe, Co, Ni, Cu, Ag, V, Cr, Mo, W and alloys or mixtures thereof. Suitably, the interfacial layer comprises carbon black supported Pt:Ru nanoparticles.

As described throughout U.S. Patent Application Publication No. 2007-0212538 and U.S. Patent Application Publication No. 2008-0280169, the nanowire-supported electrochemical catalysts can be disposed on the interfacial layer via any suitable manner, including coating, spreading, layering, spraying, dip-coating, spin-coating, etc. In exemplary embodiments, nanowires are disposed by spraying a solution of the nanowires onto the interfacial layer. Methods for spraying nanowires are well known in the art, see for example, U.S. Pat. No. 7,135,728, the disclosure of which is incorporated herein by reference. Suitably the spraying methods utilize an ultrasonic bath to prevent aggregation of the nanowires in solution, and a computer-controlled spray nozzle to deliver the nanowire solution to the surfaces. The spraying can comprise spraying multiple layers of the nanowires (and one or more ionomers), so as to create multiple layers of nanowires in the final MEA.

In further embodiments, a gas diffusion layer comprising nanowire-supported electrochemical catalysts can be disposed directly on the interfacial layer so as to generate the MEAs.

In additional embodiments, a proton-conducting membrane already comprising an interfacial layer can be provided. Supported electrochemical catalysts (e.g., carbon powder, nanowire or carbon powder-nanowire composites) can then be disposed (e.g., sprayed) onto this pre-coated or composite proton-conducting membrane.

Suitably, nanowire-supported electrochemical catalysts comprise solutions of nanowire-supported electrochemical catalysts (also called catalyst-associated nanowires throughout), for example nanowire ink solutions. The nanowire solutions of the present invention can also further comprise one or more additional components such as surfactants or polymers (for example, to aid in nanowire dispersion) and/or ionomers, such as NAFION®. Suitably, the concentration of nanowires in the various nanowires solutions are from about 0.01% to about 50% by volume, for example, about 0.1% to about 20% by volume. Suitably, the first and second compositions of catalyst metal-associated nanowires are nanowire solutions which also further comprise one or more ionomers, such as NAFION®.

Exemplary nanowire-supported electrochemical catalysts for use in the methods of the present invention include those described throughout U.S. Patent Application Publication No. 2007-0212538 and U.S. Patent Application Publication No. 2008-0280169. Suitably, one composition of nanowire-supported electrochemical catalysts comprises a solution of anode catalyst metal-associated nanowires, and a second composition of nanowire-supported electrochemical catalysts comprises a solution of cathode catalyst metal-associated nanowires. Suitably, the two solutions are disposed on opposite sides of a proton-conducting membrane comprising an interfacial layer as described herein.

As described throughout, methods for disposing the various layers of MEAs include layering, brushing, etc., and in suitable embodiments, spraying the various layers. Spraying a solution of nanowire-supported electrochemical catalysts (e.g., nanowires in an aqueous or alcohol-based solution) allows for the control of the thickness and density of the layer. In addition, one or more ionomers can be provided in the solution to be sprayed, thereby allowing for spraying of a solution of nanowire-supported electrochemical catalysts and one or more ionomers. Exemplary ionomers are described throughout and include sulphonated polymers (e.g., NAFION®) and the like.

In suitable embodiments, the concentration of nanowire-supported electrochemical catalysts are maintained constant, or relatively constant, during disposing/spraying, and the ionomer concentration is increased or decreased accordingly as the layers are sprayed to generate the gradient of ionomer concentration. In other embodiments, the concentration of ionomer can be maintained constant or relatively constant, while the concentration of nanowire-supported electrochemical catalysts is increased or decreased accordingly as the layers are sprayed thereby generating the gradient of ionomer concentration. In still further embodiments, both the concentration of the ionomer and the catalyst-associated nanowires can be adjusted as the layers are disposed to generate the gradient of ionomer concentration.

The present invention also provides membrane electrode assemblies (MEAs) prepared by the methods of the present invention. Membrane electrode assemblies prepared by the methods of the present invention can be utilized in preparation of various fuel cell electrodes, for example, in fuel cell electrode stacks. Exemplary fuel cells include oxidative fuel cells, such as methanol fuel cells, formic acid fuel cells, ethanol fuel cells, hydrogen fuel cells, ethylene glycol fuel cells and other fuel cells known those of ordinary skill in the art. The methods of the present invention, suitably the nanowire spray methods, provide a quick and easy manufacturing process for preparing a membrane electrode assembly.

For example, the present invention also provides fuel cell membrane electrode assemblies, comprising the various elements that are disposed (e.g., sprayed) in accordance with the methods disclosed herein. For example, suitable MEAs can comprise a gas diffusion layer, including gas diffusion layers comprising one or more nanowires. The MEAs can also further comprise a first composition of nanowire-supported electrochemical catalysts and ionomer adjacent the gas diffusion layer. Exemplary MEAs also comprise a proton-conducting membrane comprising an interfacial layer adjacent the first catalyst metal-associated composition, and a second composition of nanowire-supported electrochemical catalysts and ionomer adjacent the other side of the proton-conducting membrane, which also comprises an interfacial layer. In further embodiments, the MEAs can further comprise an additional gas diffusion layer adjacent the second composition of supported electrochemical catalysts.

By increasing the density of sulfonic groups on the ionomer utilized in the MEAs and varying the ionomer side chains, the characteristics, including surface groups and equivalent weight of the ionomer (e.g., Nafion) can be matched to the nanowire-supported electrochemical catalysts. This allows for an increase in the ratio of catalyst in contact with the electrolyte ionomer. For example, a Nafion ionomer having a equivalent weight (EW) of 1000, or a shorter side chain ionomer (e.g., Hyflon) with a lower EW (e.g., 850), can be utilized with nanowire-supported electrochemical catalysts in direct methanol fuel cells. Electrochemical catalysts align on the nanowire supports, thereby exposing the catalysts to large pores in the nanowire structure, thus allowing for the tailored ionomers to efficiently contact the catalysts increasing the ratio of catalysts in contact with ionomer. As used herein “tailored ionomer” refers to an ionomer that is matched to the characteristics of the nanowires of the present invention such that a greater amount of ionomer is able to reach the catalysts than if the ionomer is not appropriately matched. Suitably, the ionomer has a equivalent weight of 1000 or 850.

As described throughout, exemplary nanowires for use in the MEAs are nanowires wherein each nanowire in the network of nanowires is contacted by at least one other nanowire in the nanowire network and is electrically connected to one or more other nanowires in the nanowire network. For example, at least one of the nanowires in the network has a branched structure.

In still further embodiments, the present invention provides methods for preparing a fuel cell electrode stack utilizing the various membrane electrode assemblies disclosed throughout. The methods of the present invention can comprise assembling additional MEA layers (e.g., 2, 3, 4, 5, 6, etc., up to an n^{th} MEA) when preparing fuel cell electrode stacks. That is, any number of MEA layers up to an n^{th}, or final desired MEA layer, can be prepared in the fuel cell electrode stacks.

Typically, bipolar plates and end plates for use in the practice of the present invention are highly electrically conductive and can be made from graphite, metals, conductive polymers, and alloys and composites thereof. Materials such as stainless steel, aluminum alloys, carbon and composites, with or without coatings, are good viable options for bipolar end plates in fuel cells. Bipolar plates and end plates can also be formed from composite materials comprising highly-conductive or semiconducting nanowires incorporated in the composite structure (e.g., metal, conductive polymer etc.). While bipolar plates suitably comprise channels and/or groves on both surfaces, end plates typically only comprise channels and/or groves on the surface that is contact with the fuel cell components (i.e., the internal surface), while the external surface does not comprise such channels or groves.

The final fuel cell stacks of the present invention can then be clamped together, and fuel impregnated with a suitable electrolyte, for example, an ethylene glycol solution, methanol, formic acid, formaldehyde or small alcohols. Addition of further components as disclosed throughout and known in the art can then be added to yield a working fuel cell.

The present invention also provides fuel cells prepared by the various methods described throughout and in U.S. Patent Application Publication No. 2007-0212538 and U.S. Patent Application Publication No. 2008-0280169. As discussed herein, in suitable embodiments, the fuel cells of the present invention are oxidative fuel cells, such as a methanol fuel cell, a formic acid fuel cell, an ethanol fuel cell, a hydrogen fuel cell or an ethylene glycol fuel cell.

It will be readily apparent to one of ordinary skill in the relevant arts that other suitable modifications and adaptations to the methods and applications described herein can be made without departing from the scope of the invention or any embodiment thereof. Having now described the present invention in detail, the same will be more clearly understood by reference to the following examples, which are included herewith for purposes of illustration only and are not intended to be limiting of the invention.

### EXAMPLES

### Example 1

### Preparation of MEA with Interfacial Layer

### Preparation Before Anode Spraying

1. Clean the vacuum plate, anode spraying mat and spraying template with isopropanol.

2. Place PTFE coated fabric spraying template onto vacuum plate and dry for 1 minute.

3. Place a Nafion membrane on the PTFE coated fabric. Remove wrinkles and air bubbles.

4. Turn on vacuum.

5. Place and secure spraying mat on top of the membrane.

6. Set vacuum plate to 90° C.

### Anode Ink Preparation

1. Measure required amount of PtRu/C or PtRu/NW into a clean vial.

2. Add appropriate Millipore water to the vial

3. Measure required amount of ionomer solution into another clean vial.

4. Add appropriate IPA in the vial containing ionomer solution and mix them sufficiently.

5. Add IPA-diluted ionomer solution into the vial of the catalyst/water mixture.

6. Adjust the power setting on the sonic homogenizer to a setting between 20% and 40% as required, ¾″ probe.

7. Sonicate the mixture in the vial for 1 to 5 min.

8. This is the anode ink. It should appear as a uniform liquid suspension.

### Anode Spraying

1. After the temperature becomes 90° Celsius, start the spraying program.

2. Spray the PtRu/C ink to make three layers on the membrane.

3. During spraying, the PtRu/C ink is stirred to avoid catalyst precipitation.

4. Then spray the PtRu/NW ink on the membrane.

5. Repeat step 3 until all the prepared ink has been sprayed onto the membrane to make a required catalyst loading.

6. After spraying, maintain the plate temperature at 90° Celsius for 10 min to make sure the catalyst layer has dried out out.

7. Turn off the heater and cool the electrode down to room temperature (lower than 30° Celsius).

8. Turn off vacuum.

9. Turn over the membrane and repeat steps 1-8 to make a cathode on the membrane

10. Place the MEA into a bag and keep it flat till it is used.

### Example 2

### Preparation of MEA with Matching Ionomer

The nanowire-supported electrochemical catalysts (e.g., Pt:Ru/nanowire catalysts) of the present invention provide distinct advantages over commercially available carbon-supported catalysts (e.g., Pt:Ru/Carbon black or carbon paper), including the absence of primary pores (e.g., no pores less than 20 nm), as well as dimensional matching between the porous structure of the nanowire catalysts and the ionomer utilized, and efficient collection of current from carburized nanowires.

By increasing the density of sulfonic groups on the ionomer and varying the ionomer side chains, the ionomer (e.g., Nafion) is able to be matched to the nanowire-supported electrochemical catalysts, thereby increasing the ratio of catalyst in contact with the electrolyte ionomer. For example, a Nafion ionomer having a equivalent weight (EW) of 1000, or a shorter side chain ionomer (e.g., Hyflon) with a lower EW (e.g., 850) provides enhanced performance of the nanowire-supported electrochemical catalysts in direct methanol fuel cells. The nanowire-supported electrochemical catalysts align on the nanowire supports, thereby exposing the catalysts to large pores in the nanowire structure, thus allowing for the tailored ionomers to efficiently contact the catalysts increasing the ratio of catalysts in contact with ionomer.

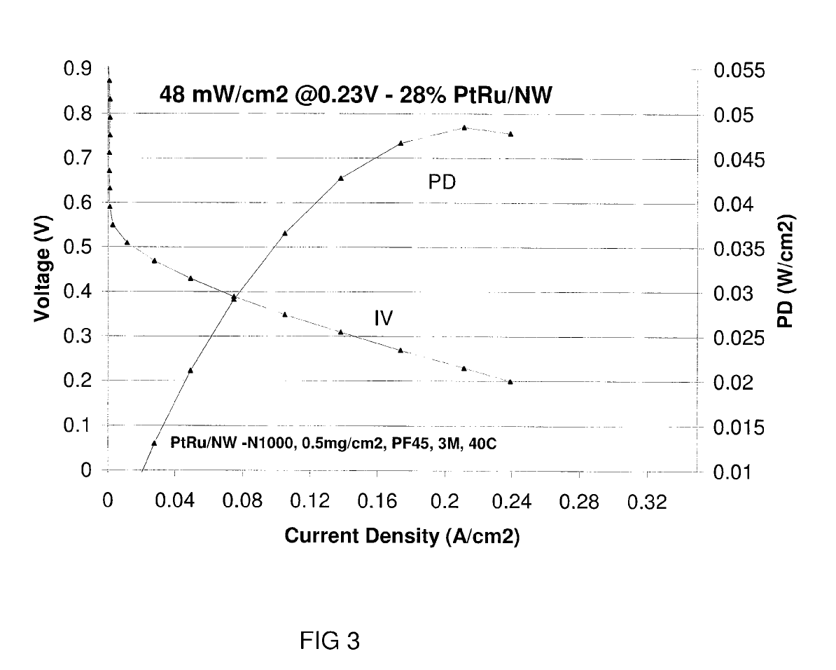

Performance characteristics of a 5 cm² methanol fuel cell comprising the nanowire-associated electrochemical catalysts of the present invention were determined using various methods. FIG. 3 shows the voltage and power density (PD) of Pt:Ru nanowire-associated catalysts in a fuel cell utilizing a EW1000 Nafion ionomer. The PD at 0.23V was measured to be 48 mW/cm² for a catalyst comprising 28% Pt:Ru associated nanowire catalysts at a very low loading of 0.5 mg/cm² for the DMFC with 3M methanol solution at 40° C.

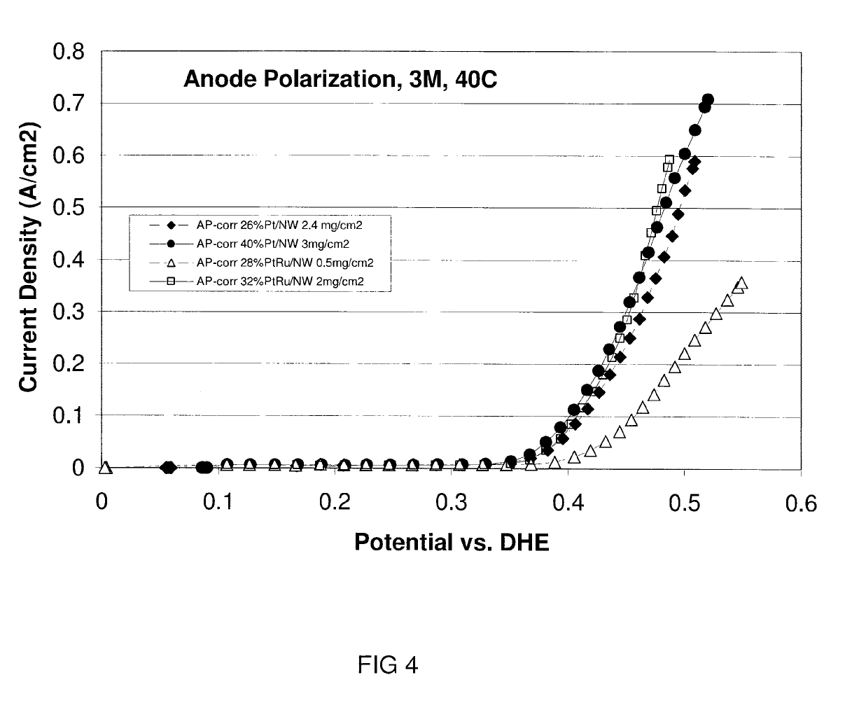

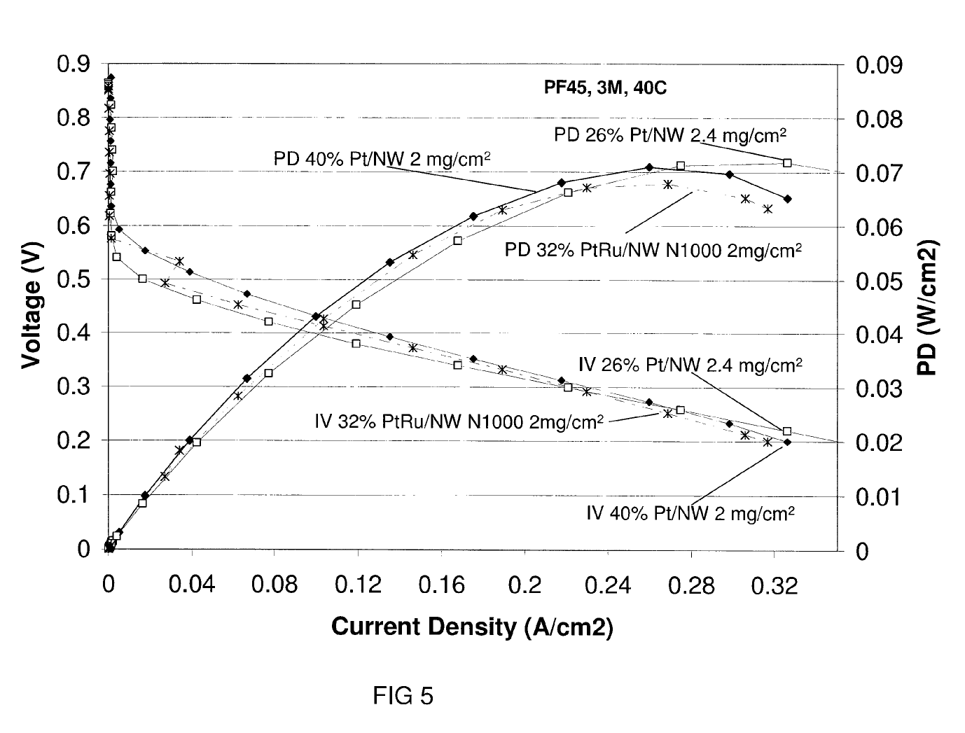

FIG. 4 shows the results of anode polarization representing the current density versus potential vs. DHE for four exemplary nanowire-associated catalysts of the present invention at different percentages of Pt and Pt:Ru catalyst and density. 32% PtRu/NW catalyst showed better performance than PtRu/C catalyst because the loading for 32% PtRu/NW is 2 mg/cm², which is lower than 52% PtRu/C (2.4 mg/cm² or 3 mg/cm²). The MEAs used in FIG. 4 include the following: 52% PtRu/C(TKK)-anode/26% Pt/NW-cathode, 2.4 mg/cm², EW1100 ionomer; 52% PtRu/C(TKK)-anode/40% Pt/NW-cathode, 3 mg/cm², EW 1100; 32% PtRu/NW-anode/46% Pt/C(TKK)-cathode EW1000, 2 mg/cm²; 28% PtRu/NW-anode/46% Pt/C (TKK)-cathode, EW 1100, 0.5 mg/cm².

FIG. 5 compares the Voltage and Power Density as a function of current density for Pt and Pt:Ru nanowire associated catalysts, including the impact of EW1000 Nafion on performance. The MEAs used in FIG. 5 include the following: 52% PtRu/C(TKK)-anode/26% Pt/NW-cathode, 2.4 mg/cm², EW1100 ionomer; 52% PtRu/C(TKK)-anode/40% Pt/NW-cathode, 2 mg/cm², EW1100; 32% PtRu/NW-anode/46% Pt/C(TKK)-cathode EW1000, 2 mg/cm². When the same anode PtRu/C catalysts was used, the 40% Pt/NW cathode showed better performance over the 26% Pt/NW cathode catalyst. When 46% Pt/C cathode was used, the 32% PtRu/NW anode gave a DMFC performance as good as PtRu/C anode. The ionomer (EW1000) in the PtRu/NW anode layer performed well in the catalyst too. The results in this figure indicate that the Pt/NW cathode catalysts showed promising results.

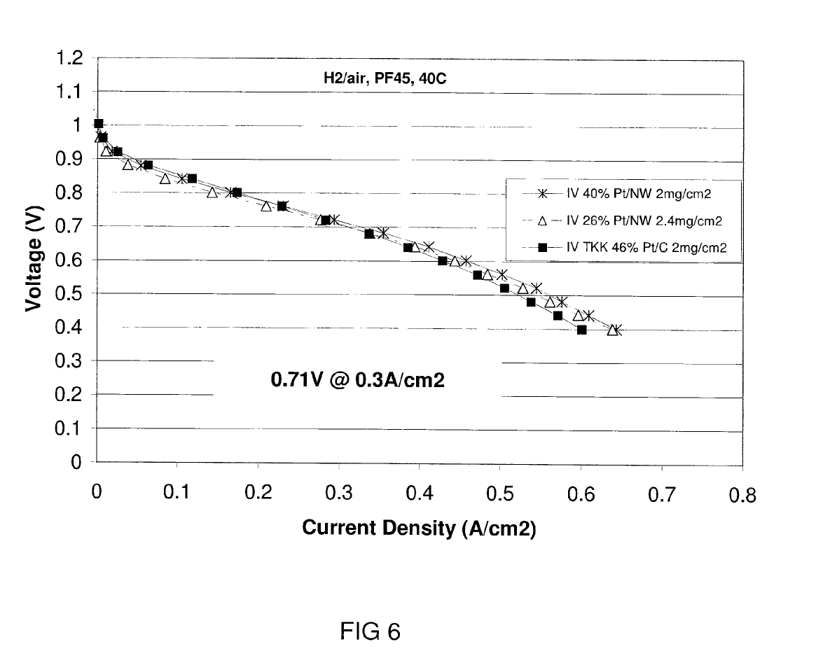

FIG. 6 shows the cathode polarization of two different concentrations of Pt-catalyst-associated nanowires of the present invention as compared with a Pt-Carbon-associated catalyst (TKK). A voltage of 0.71V was achieved at a current density of 0.3 A/cm². This provides direct evidence that both 40% Pt/NW and 26% Pt/NW cathode catalysts perform as well as conventional Pt/C catalyst under hydrogen-air fuel cell conditions.

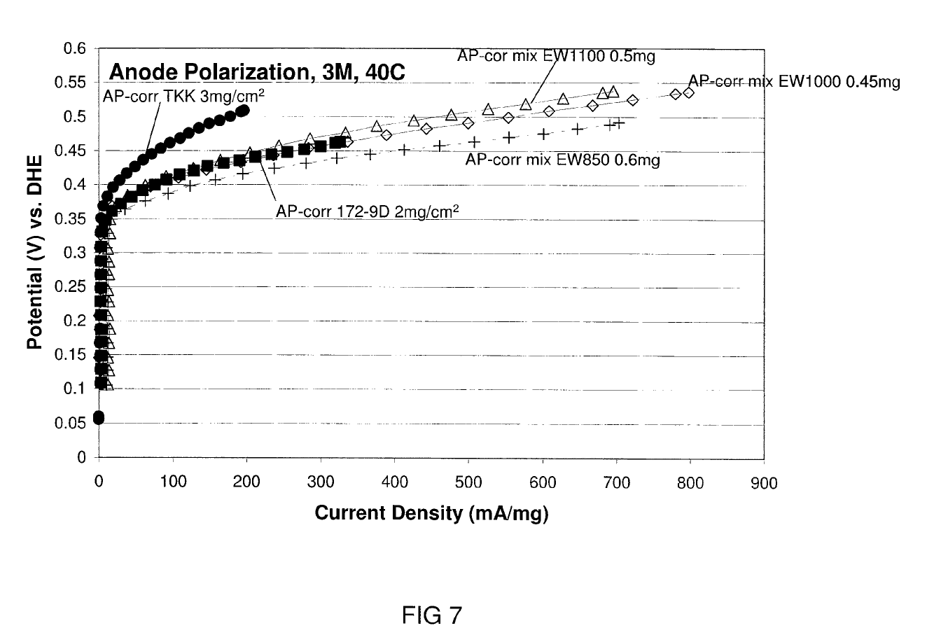

FIG. 7 shows the anode potential versus mass current per Pt:Ru metal weight (mA/mg-PtRu) in Pt:Ru-carbon supported catalyst (TKK) compared with four Pt:Ru-nanowire-supported anode catalysts of the present invention. Nafion with EW 1000 was utilized for the carbon-supported catalyst, as well as nanowire supported catalysts (0.45 mg/cm² loading and 2 mg/cm² loading, respectively.). The nanowire supported PtRu catalysts showed better mass activity over the carbon supported catalyst with the identical ionomer EW1000. Nafion with EW1100 and EW1000, and Hyflon with EW850, were utilized for nanowire-supported PtRu catalysts and compared. A clear trend in performance was observed: EW850>EW1000>EW1100 for PtRu/NW catalysts. The metal content of Pt:Ru nanowire-supported electrochemical catalysts was 30%. The anode polarization performance was evaluated at 40° C. by feeding 3 mol/L of methanol to the anode and hydrogen to the cathode. The results are also presented below in Table 1.

TABLE 1

| Current Density | Anode 27708 w/EW850 | Anode 27708 w/EW1000 | Anode 27708 w/EW1100 | Delta V of | Delta V of |
|---|---|---|---|---|---|
| (mA/mg) | (Anode Potential (V)) | (Anode Potential (V)) | (Anode Potential (V)) | EW1000 and EW850 | EW1100 and EW850 |
| 100 | 0.387 | 0.406 | 0.414 | 0.019 | 0.027 |
| 200 | 0.417 | 0.432 | 0.445 | 0.015 | 0.028 |
| 300 | 0.435 | 0.456 | 0.470 | 0.021 | 0.035 |

### EXAMPLE 3

### Performance of MEA with Interfacial Layer

An anode electrode of a membrane electrode assembly was prepared by following procedure. The hydrocarbon membrane is placed onto the vacuum table and covered by mask which has the 5 cm² opening. The vacuum table is heated 60° C.

A carbon-supported electrochemical catalyst dispersion is prepared by mixing and ultrasonicating carbon supported electrochemical catalyst (e.g, 50wt % Pt:Ru supported on Ketjenblack manufactured by Tanaka Kikinzonku Kogyo), solubilized perfluorosulfonate ionomer (e.g., Nafion solution purchased from Sigma-Aldrich), water, and isopropyl alcohol. The obtained carbon supported electrochemical catalyst dispersion is applied to the surface of a hydrocarbon membrane by brush painting. The catalyst metal loading of the carbon supported electrochemical catalyst layer was 0.5 mg-Pt:Ru/cm².

A nanowire-supported electrochemical catalyst dispersion is prepared by mixing and ultrasonicating nanowire-supported electrochemical catalyst (e.g, 30 wt % Pt:Ru supported on carburized nanowires), solubilized perfluorosulfonate ionomer (e.g., Nafion solution purchased from Sigma-Aldrich), water, and isopropyl alcohol. The obtained nanowire supported electrochemical catalyst dispersion is applied to the surface of the layer of a carbon-supported electrochemical catalyst by brush painting. The catalyst metal loading of nanowire supported electrochemical catalyst layer was 2 mg-PtRu/cm².

The cathode electrode of a membrane electrode assembly was prepared by brush painting the carbon supported electrochemical dispersion on the other side of the anode electrode. In the case of the cathode electrode, the carbon supported electrochemical catalyst is 50 wt % Pt supported on Ketjenblack manufactured by Tanaka Kikinzoku Kogyo.

The obtained membrane electrode assembly was sandwiched by a gas diffusion layer (e.g. GDL35BC manufactured by SGL carbon) and installed into test cell manufactured by Fuel Cell Technologies Inc. The direct methanol fuel cell (DMFC) performance is evaluated at 40° C. by feeding 3 mol/L of methanol to the anode and air to the cathode.

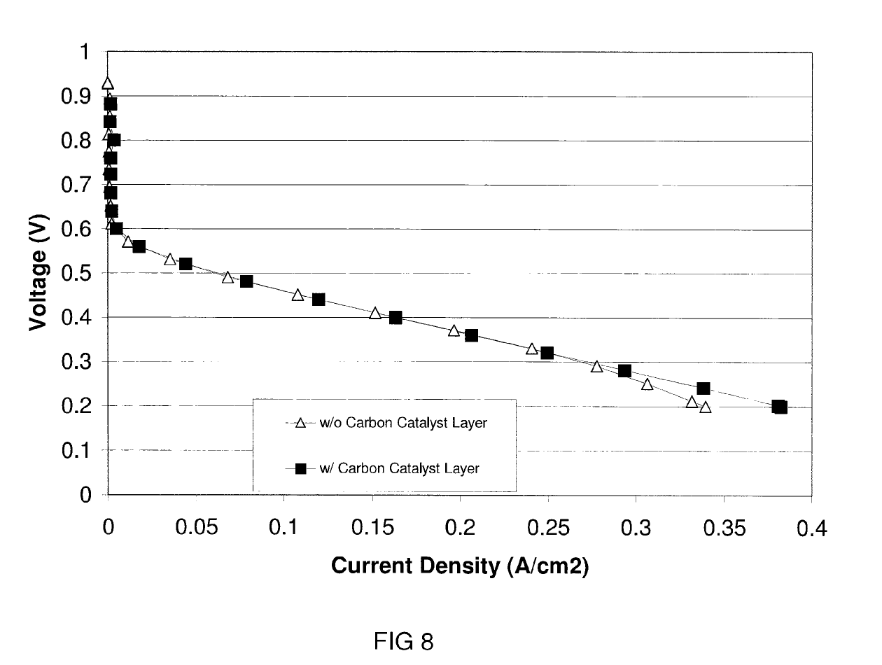

FIG. 8 shows the DMFC polarization performance (potential (V) vs. current density (mA/cm²)) with and without the layer of carbon supported electrochemical catalysts in the anode electrode. The DMFC with the layer of the carbon-supported electrochemical catalysts produced a greater current than that produced by the DMFC without the layer of the carbon supported-electrochemical catalysts. A possible reason for this is that a cell resistance was reduced by an increased adhesion provided by the layer of the carbon-supported electrochemical catalysts. Another possible reason for this is that the layer of the carbon-supported electrochemical catalysts prevented methanol crossover and thereby flooding of the cathode was prevented.

A further example follows.

The hydrocarbon membrane is soaked in solubilized perfluorosulfonate ionomer solution (HYFLON PFA manufactured by Solvay Solexis) for 1 week. The treated hydrocarbon membrane is placed onto the vacuum table and covered by mask which has the 5 cm² opening. The vacuum table is heated 60° C.

The carbon-supported electrochemical catalyst dispersion is prepared by mixing and ultrasonicating carbon-supported electrochemical catalyst (e.g, 50 wt % Pt:Ru supported on Ketjenblack manufactured by Tanaka Kikinzonku Kogyo), solubilized perfluorosulfonate ionomer (e.g., Nafion solution purchased from Sigma-Aldrich), water, and isopropyl alcohol. The obtained carbon-supported electrochemical catalyst dispersion is applied to the surface of a hydrocarbon membrane by brush painting to form an anode electrode. The catalyst metal loading of the anode was 0.6 mg-Pt:Ru/cm².

The cathode electrode of membrane electrode assembly was prepared by brush painting the carbon supported electrochemical dispersion on the other side of the anode electrode. In the case of the cathode electrode, the carbon supported electrochemical catalyst is 50 wt % Pt supported on Ketjenblack manufactured by Tanaka Kikinzoku Kogyo.

The obtained membrane electrode assembly was sandwiched by a gas diffusion layer (e.g. GDL35BC manufactured by SGL carbon) and installed into test cell manufactured by Fuel Cell Technologies Inc. The direct methanol fuel cell (DMFC) performance is evaluated at 40° C. by feeding 3 mol/L of methanol to the anode and air to the cathode.

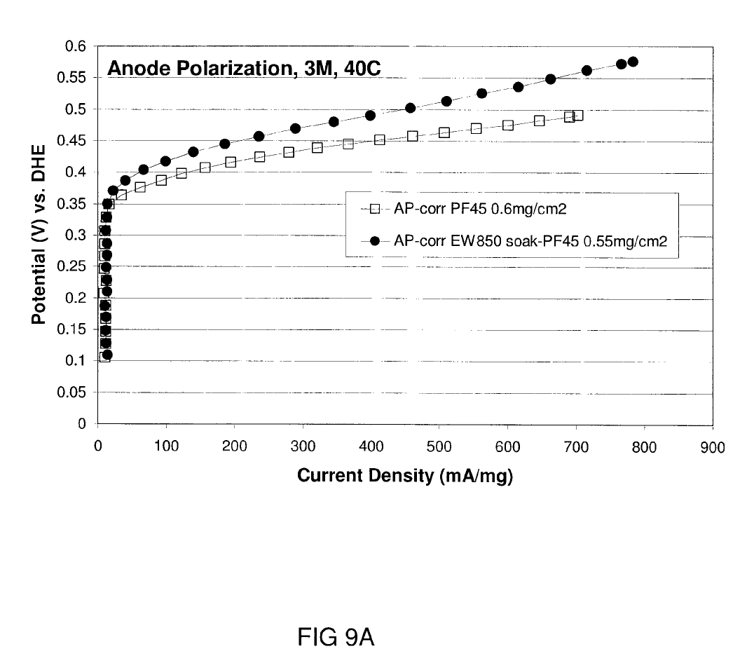

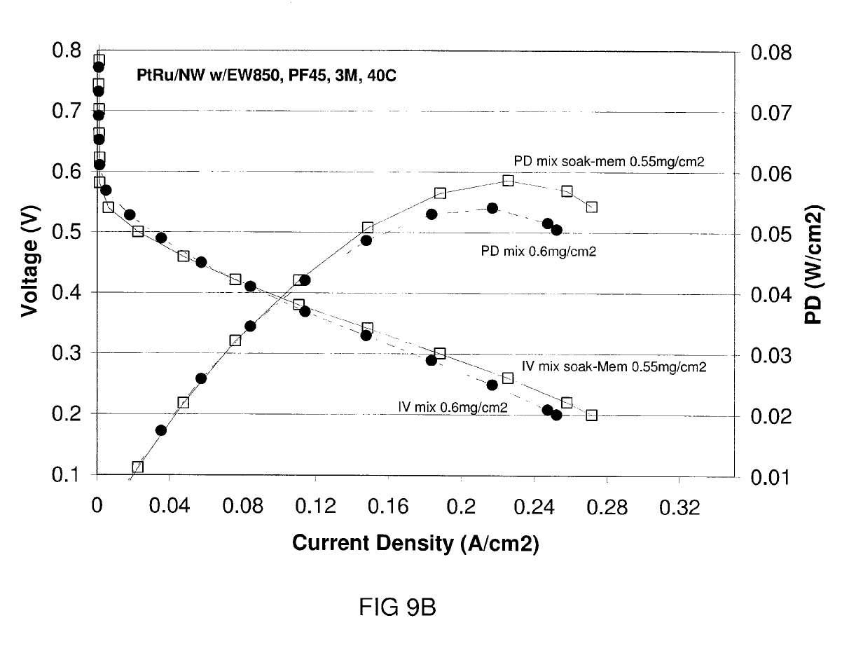

FIGS. 9A and 9B show the anode and DMFC polarization performance, respectively, with and without membrane treatment with solubilized perfluorinated ionomer solution (soak). The results demonstrate an enhanced performance due to the treatment with ionomer solution. Soaking the hydrocarbon membrane in a solubilized perfluorinated ionomer solution forms the layer of the perfluorinated ionomer on the surface of the hydrocarbon membrane. Although the hydrocarbon membrane after the soaking exhibited an anode polarization performance inferior to that of the hydrocarbon membrane after the soaking, the direct methanol fuel cell with the hydrocarbon membrane after the soaking exhibited a higher electricity generation performance. A possible reason for this is that providing the layer of the perfluorinated ionomer on the surface of the hydrocarbon membrane improved adhesion between the hydrocarbon membrane and the proton-conducting membrane 102, thereby reducing cell resistance. Further, even with a small amount of catalysts, the hydrocarbon membrane after the soaking provided a higher electricity generation performance to the direct methanol fuel cell, as compared with the hydrocarbon membrane before a soaking, in an electricity generation test.

Exemplary embodiments of the present invention have been presented.

The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

All publications, patents and patent applications mentioned in this specification are indicative of the level of skill of those skilled in the art to which this invention pertains, and are herein incorporated by reference to the same extent as if each individual publication, patent or patent application was specifically and individually indicated to be incorporated by reference.

What is claimed is:

1. A fuel cell membrane electrode assembly, comprising:
(a) a proton-conducting membrane layer;
(b) an interfacial layer adjacent the proton-conducting membrane layer; and
(c) one or more nanowire-supported electrochemical catalysts adjacent the interfacial layer.

2. The fuel cell membrane electrode assembly of claim 1, wherein the proton-conducting membrane comprises a hydrocarbon.

3. The fuel cell membrane electrode assembly of claim 1, wherein the interfacial layer comprises carbon-supported electrochemical catalysts.

4. The fuel cell membrane electrode assembly of claim 1, wherein the interfacial layer comprises a perfluorinated polymer electrolyte.

5. The fuel cell membrane electrode assembly of claim 1, wherein the interfacial layer comprises carbon black.

6. The fuel cell membrane electrode assembly of claim 1, wherein the electrochemical catalysts comprise nanoparticles of about 1 nm to about 10 nm.

7. The fuel cell membrane electrode assembly of claim 1, wherein the electrochemical catalysts comprise nanoparticles comprising metal selected from the group consisting of Pt, Au, Pd, Ru, Re, Rh, Os, Ir, Fe, Co, Ni, Cu, Ag, V, Cr, Mo, W and alloys or mixtures thereof

8. The fuel cell membrane electrode assembly of claim 7, wherein the nanoparticles comprise Pt:Ru.

9. The fuel cell membrane electrode assembly of claim 3, wherein the nanowire-supported electrochemical catalysts and the carbon-supported electrochemical catalysts comprise nanoparticles comprising metal selected from the group consisting of Pt, Au, Pd, Ru, Re, Rh, Os, Ir, Fe, Co, Ni, Cu, Ag, V, Cr, Mo, W and alloys or mixtures thereof.

10. The fuel cell membrane electrode assembly of claim 7, wherein the nanoparticles comprise Pt:Ru.

11. The fuel cell membrane electrode assembly of claim 1, wherein the nanowires are selected from the group consisting of C, RuO₂, SiC, GaN, TiO₂, SnO₂, WCₓ, MoCₓ, ZrC, WNₓ, and MoNₓ nanowires, wherein x is a positive integer.

12. The fuel cell membrane electrode assembly of claim 1, further comprising an anode and/or cathode electrode.

13. The fuel cell membrane electrode assembly of claim 1, wherein the membrane electrode assembly is a component in a methanol fuel cell, a formic acid fuel cell, an ethanol fuel cell, a hydrogen fuel cell or an ethylene glycol fuel cell.

14. The fuel cell membrane electrode assembly of claim 1, wherein the nanowire-supported electrochemical catalysts are in contact with an electrolyte ionomer whose equivalent weight is not more than 1000.

15. The fuel cell membrane electrode assembly of claim 1, wherein the nanowire-supported electrochemical catalysts form an interconnected network structure.

16. The fuel cell membrane electrode assembly of claim 1, wherein the nanowire-supported electrochmeical catalysts are in contact with an electrolyte ionomer.

17. A method of preparing a fuel cell membrane electrode assembly, comprising:
(a) providing a proton-conducting membrane layer;
(b) disposing an interfacial layer adjacent the proton-conducting membrane layer; and
(c) disposing one or more nanowire-supported electrochemical catalysts adjacent the interfacial layer.

18. The method of claim 17, wherein the providing comprises providing a hydrocarbon proton-conducting membrane.

19. The method of claim 17, wherein the disposing in (b) comprises disposing carbon-supported electrochemical catalysts.

20. The method of claim 17, wherein the disposing in (b) comprises disposing a perfluorinated polymer electrolyte.

21. The method of claim 17, wherein the disposing in (b) comprises disposing carbon black.

22. The method of claim 17, wherein the disposing in (b) comprises spraying the interfacial layer onto the proton-conducting membrane layer.

23. The method of claim 17, wherein the disposing in (c) comprises disposing nanowire-supported electrochemical catalyst nanoparticles of about 1 nm to about 10 nm.

24. The method of claim 23, wherein the disposing in (c) comprises disposing nanowire-supported electrochemical catalyst nanoparticles, where the nanoparticles comprise metal selected from the group consisting of Pt, Au, Pd, Ru, Re, Rh, Os, Ir, Fe, Co, Ni, Cu, Ag, V, Cr, Mo, W and alloys or mixtures thereof.

25. The method of claim 24, wherein the disposing comprises disposing nanowire-supported electrochemical catalyst nanoparticles, wherein the nanoparticles comprise Pt:Ru.

26. The method of claim 19, wherein the disposing in (b) comprises disposing carbon-supported electrochemical catalysts comprising nanoparticles comprising metal selected from the group consisting of Pt, Au, Pd, Ru, Re, Rh, Os, Ir, Fe, Co, Ni, Cu, Ag, V, Cr, Mo, W and alloys or mixtures thereof.

27. The method of claim 26, wherein the disposing in (b) comprises disposing carbon-supported electrochemical catalysts wherein the nanoparticles comprise Pt:Ru.

28. The method of claim 17, wherein the disposing in (c) comprises disposing nanowire-supported electrochemical catalyst nanoparticles, where the nanowires are selected from the group consisting of C, RuO₂, SiC, GaN, TiO₂, SnO₂, WCₓ, MoCₓ, ZrC, WNₓ, and MoNₓ nanowires, wherein x is a positive integer.

29. The method of claim 17, wherein the disposing in (c) comprises spraying the nanowire-supported electrochemical catalysts on the interfacial layer.
